(19) United States
(12) Patent Application Publication
(10) Pub. No.: US 2011/0202877 A1
(43) Pub. Date: Aug. 18, 2011

(54) Apparatus and Method for Controlling a Display to Provide Content Navigation

(75) Inventors: Christian Lassonde, Toronto (CA); Dale Darling, Toronto (CA); Prasad Maruvada, Etobicoke (CA); Matthew Sharpe, Guelph (CA); Dimitar Genov, Toronto (CA); Lumi Necula, Ajax (CA); Kevin Grant, Toronto (CA)

(73) Assignee: METACAN HOLDINGS INC., Toronto (CA)

(21) Appl. No.: 13/028,452

(22) Filed: Feb. 16, 2011

Related U.S. Application Data
(60) Provisional application No. 61/338,224, filed on Feb. 16, 2010.
(60) Provisional application No. 61/349,930, filed on May 31, 2010.

(51) Int. Cl. G06F 3/048

(52) U.S. Cl. 715/817

(57) ABSTRACT

An apparatus and method for controlling a display to provide content navigation is provided. In an aspect, a plurality of graphical cascades are created, where at least one of the graphical cascades is provided for menu navigation, and another of the graphical cascades is provided for actual generation of content. New menus automatically open in the foreground of a cascade.

### FIELD OF THE INVENTION

The present specification relates generally to computing and more specifically relates to an apparatus and method for controlling a display to provide content navigation.

### BACKGROUND OF THE INVENTION

As traditional content platforms such as television, radio, compact disc players, video disc players, books, and magazines wane, there is a concurrent increase in the use of computers as a replacement and converged platform.

Systems currently exist for navigating through the aforementioned content. However, these exiting systems are, in certain ways, difficult to use. For example, in common content navigation systems, it is easy to lose track of content menus, with the result that the user will have to hunt around with his mouse pointer on the display to find a menu that he had previously opened. Second, the benefits of existing content navigation systems are often difficult for the user to discover. For example, some common content navigation systems (e.g. tabbed browsers in Windows™) allow queuing of content (such as webpages), but that functionality requires the user to know that he must right-click on a link and select “open in new tab”. Third, browsing between menus is often difficult. In the example of tabbed browsers, to switch between tabs, a user has to hover the mouse into the tab area of the browser window, and where many tabs are open, scrolling may be required to reach the desired tab, making browsing difficult and inconvenient.

### SUMMARY OF THE INVENTION

Therefore, what is desired is an apparatus and method for controlling a display to provide content navigation which facilitates efficient, convenient and organized content navigation.

According to one aspect of the invention, there is provided a computer-implemented method of controlling a display to provide content navigation, comprising the steps of: (a) controlling said display to activate a first graphical cascade to show a root menu in said first graphical cascade, said root menu comprising a first set of menu items; (b) in response to a selection of one of the first set of menu items, controlling the display to (I) activate a second menu, corresponding to said one of the first set of menu items, so as to automatically show the second menu in a foreground of the first graphical cascade, and (II) automatically move the root menu so as to show the root menu in a background of the first graphical cascade; said second menu comprising a second set of menu items; and in response to a selection of one of the second set of menu items, controlling said display to automatically activate a third menu in a second graphical cascade adjacent to said first graphical cascade, the third menu corresponding to the one of the second set of menu items, and comprising a third set of menu items. Preferably, the method further comprises the step of in response to a selection of another of the second set of menu items, controlling the display to (I) activate a fourth menu corresponding to said other of the second set of menu items, so as to automatically show the fourth menu in a foreground of the second graphical cascade; and (II) automatically move the third menu to show the third menu in a background of the second graphical cascade; the fourth menu comprising a fourth set of menu items. Optionally, the method may comprise the step of, in response to a selection of one of the third set of menu items, automatically activating a third graphical cascade, including an activated content link corresponding to the one of the third set of menu items.

According to one aspect of the invention, there is provided a computer-implemented method of controlling a display to provide content navigation, comprising the steps of: (a) in response to a user selection, controlling said display to automatically activate a menu in a foreground of a first graphical cascade, said menu comprising a first set of menu items; (b) in response to a selection of one of the first set of menu items, controlling the display to (I) activate a next menu, corresponding to said one of the first set of menu items, so as to automatically show the next menu in a foreground of the first graphical cascade, and (II) automatically move the menu so as to show the menu in a background of the first graphical cascade; said next menu comprising a second set of menu items; and (c) in response to a selection of one of the second set of menu items, controlling said display to automatically activate a further menu in a second graphical cascade adjacent to said first graphical cascade, the further menu corresponding to the one of the second set of menu items, and comprising a third set of menu items. Optionally, the method further comprises the step of: in response to a selection of another of the second set of menu items, controlling the display to (I) activate an additional menu corresponding to said other of the second set of menu items, so as to automatically show the additional menu in a foreground of the second graphical cascade; and (II) automatically move the next menu to show the next menu in a background of the second graphical cascade; the additional menu comprising an additional set of menu items. Optionally, the method further comprises the step of: in response to a selection of one of the third set of menu items, automatically activating a third graphical cascade, including an activated content link corresponding to the one of the third set of menu items. Optionally, each menu item in said first set and said second set has associated therewith metadata identifying it as being in a first category of items the selection of which automatically activates a new menu in the graphical cascade in which said each menu item is located, or a second category of items the selection of which automatically activates a new menu in another graphical cascade. Optionally, the method further comprises the steps of (1) upon selection of said one of said first set of menu items, determining that said one of said first set of menu items is in the first category, and (2) upon selection of said one of said second set of menu items, determining that said one of said second set of menu items is in the second category.

According to another aspect of the invention, there is provided a computer-implemented method of displaying a graphical cascade array, the method comprising the steps of (a) receiving a content index (b) identifying a root of the index (c) identifying content links in the index (d) building a graphical cascade array and (e) using the array, displaying a graphical cascade, the graphical cascade including a plurality of menus, a root menu corresponding to a root of the index being shown in a background of the graphical cascade, and another menu corresponding to a node at a sublevel of the index being shown at a foreground of the graphical cascade.

According to another aspect of the invention, there is provided a computer-implemented method for navigating within a graphical cascade, the graphical cascade comprising a plurality of menus in a stack, wherein a first one of the plurality of menus is shown in a foreground, and the rest of the plurality of menus are in the background, the graphical cascade being displayed on a touchscreen display, the method comprising the steps of (a) swiping the touchscreen on or near the cascade in a first direction to remove the first one of the plurality of menus from the display, and cause a next menu in the stack to be displayed in the foreground and (b) swiping the touchscreen on or near the cascade in a first direction to remove the next menu from the display and cause a following menu in the stack to be displayed in the foreground. Preferably, the method further comprises the step of swiping the screen in a second direction on or near the cascade to return the next menu to the display and cause the next menu to be shown in the foreground. Preferably, the method further comprises the step of swiping the screen in a second direction on or near the cascade to return the first one of the plurality of menus to the display and cause the first one of the plurality of menus to be shown in the foreground. Optionally, the graphical cascade is displayed adjacent to a first side edge of the touchscreen display, swiping the touchscreen in the first direction comprises swiping the touchscreen in a direction from the vertical centre-line of the display toward the first side edge, and swiping the touchscreen in the second direction comprises swiping the touchscreen in a direction from the first side edge toward the vertical centre-line of the display. Optionally, the graphical cascade is displayed adjacent to one of a top edge or a bottom edge of the touchscreen display, swiping the touchscreen in the first direction comprises swiping the touchscreen from right to left, and swiping the touchscreen in the second direction comprises swiping the touchscreen from left to right. Preferably, the method further comprises maintaining the first one of the plurality of menus in a memory operatively connected to the display after the first one of the plurality of menus has been removed from the display. Preferably, the method further comprises maintaining the next menu in a memory operatively connected to the display after next menu has been removed from the display.

According to another aspect of the invention, there is provided a computer-implemented method for navigating within a first graphical cascade and a second graphical cascade, each graphical cascade comprising a plurality of menus in a stack wherein a first one of the plurality of menus is shown in a foreground and the rest of the plurality of menus are in the background, each graphical cascade being displayed on a touchscreen display, the first graphical cascade being positioned to the left side of the display and second graphical cascade being displayed on the right side of the display, the method comprising the steps of (a) swiping the touchscreen from right to left on or near the first cascade to remove the first cascade's first one of the plurality of menus from the display, and cause a next menu in the stack of the first cascade to be displayed in the foreground (b) swiping the touchscreen from left to right on or near the second cascade to remove the second cascade's first one of the plurality of menus from the display, and cause a next menu in the stack of the second cascade to be displayed in the foreground. Preferably, the method comprises the steps of (1) swiping the touchscreen from left to right on or near the first cascade to return the first cascade's first one of the plurality of menus to the display and cause the first cascade's first one of the plurality of menus to be shown in the foreground, and (2) swiping the touchscreen from right to left on or near the second cascade to return the second cascade's first one of the plurality of menus to the display and cause the second cascade's first one of the plurality of menus to be shown in the foreground. Preferably, the method further comprises maintaining the first and second cascades' first ones of the plurality of menus in a memory operatively connected to the display after the first and second cascades' first ones of the plurality of menus has been removed from the display.

### BRIEF DESCRIPTION OF THE DRAWINGS

FIG. 1 shows a system for controlling a display to provide content navigation.

FIG. 2 shows a computer-based method for building a data representation of a graphical cascade array.

FIG. 3 shows an example content index.

FIG. 4 shows a flowchart depicting a method of how one of the blocks from FIG. 2 can be implemented.

FIG. 5 shows an example root menu that can be generated using the method of FIG. 4.

FIG. 6 shows examples of other menus that can be generated using the method of FIG. 4.

FIG. 7 shows examples of other menus that can be generated using the method of FIG. 4.

FIG. 8 shows a method for controlling a display to provide content navigation.

FIG. 9 shows the system of FIG. 1 during example performance of blocks from the method of FIG. 8.

FIG. 10 shows the system of FIG. 1 during example performance of blocks from the method of FIG. 8.

FIG. 11 shows the system of FIG. 1 during example performance of blocks from the method of FIG. 8.

FIG. 12 shows another method for controlling a display to provide content navigation.

FIG. 13 shows the system of FIG. 1 during example performance of blocks from the method of FIG. 12.

FIG. 14 shows the system of FIG. 1 during example performance of blocks from the method of FIG. 12.

FIG. 15 shows the display of FIG. 1 with the addition of a third graphical cascade.

FIG. 16 shows the display of FIG. 15 with changes to the third graphical cascade.

FIG. 17 shows the display of FIG. 16 with changes to the second graphical cascade.

FIG. 18 shows a modified version of the display of FIG. 17.

FIG. 19 shows the display of FIG. 18 and how navigation can be effected thereon.

FIG. 20 shows a modified version of the content index of FIG. 3.

FIG. 21 shows a display with an example graphical cascade for navigation.

FIG. 22 shows the example graphical cascade of FIG. 21 after a navigation step.

FIG. 23 shows the example graphical cascade of FIG. 21 after another navigation step.

### DETAILED DESCRIPTION OF THE PREFERRED EMBODIMENTS

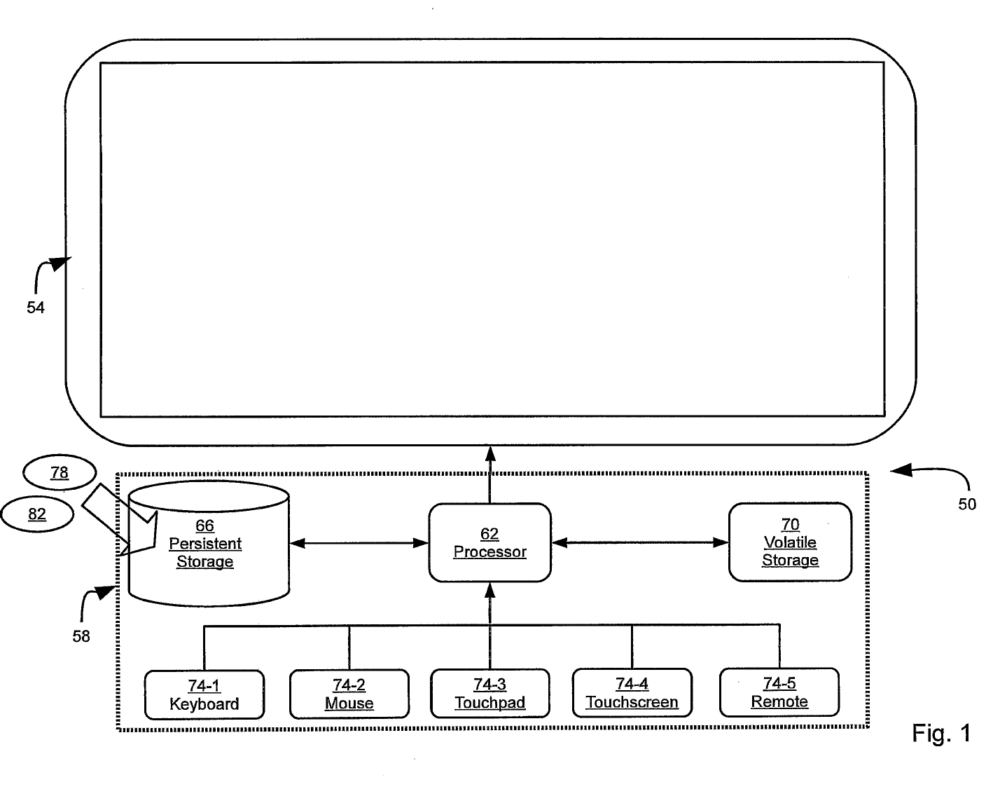

Referring now to FIG. 1, a system for controlling a display is indicated generally at 50. In a present embodiment system 50 comprises a display 54 and an apparatus 58 for controlling display 54. System 50 can be implemented in a wide variety of platforms, including without limitation, desktop computers, laptop computers, tablet computers (which may also be referred to as pad-type computers), notebook computers, netbook computers, portable video game players, cellular telephones, kiosks, automated teller machines, televisions and including the option for three-dimensional display variations on any of the foregoing. The application to three-dimensional displays will become apparent below. Other types of platforms will now occur to those skilled in the art.

It will be understood that the exact configuration of display 54 and apparatus 58 can vary according to the type of platform. Accordingly, display 54 can be implemented using any desired display technologies, including as a liquid crystal display, an organic light emitting diode (OLED) display, a cathode ray tube or a projector. By the same token apparatus 58 can be implemented using any computing hardware structures that are capable of controlling display 54. A non-limiting, and simplified example of such a computing hardware structure for apparatus 58 is shown in FIG. 1 and comprises at least one processor 62 that is coupled to at least one persistent storage device 66, at least one volatile storage device 70, and at least one input device 74-1, 74-2, . . . 74-5. (Collectively, input devices 74, and generically, input device 74).

Processor 62 can be based on any known or future contemplated microprocessor(s), including those offered by Intel™, Advanced Microdevices™, Motorola™, or others. A plurality of processors 62 may be employed, or multiple core processors may be employed or combinations thereof. For example, it is common on a personal computer to have a central processing unit, as well as a separate microprocessor located on a video controller card. Such configurations, and variations thereon, are contemplated.

Persistent storage device 66 can comprise any type of persistent storage, including but not limited to one or more of a hard disc drive, an optical disc drive, FLASH, or a redundant array of inexpensive disks (RAID). Persistent storage device 66 can also be located remotely from processor 62, such as on a remote file server or web server, in which case the link between processor 62 and persistent storage device 66 can be based on the Internet or any other network topography. Again, the type of persistent storage device 66 will typically complement the platform of system 50. As will be discussed further below, persistent storage device 66 maintains a data representation of a graphical cascade array 78 and content 82.

Volatile storage 70 can comprise random access memory (RAM) or the like.

Input devices 74, in the present example, comprise a keyboard 74-1, a mouse 74-2, a touchpad 74-3, a touchscreen 74-4 and a remote control 74-5. It should be understood that only one input device of one of these types need be provided, and also that other types of input devices, not shown, such as video game controllers, are contemplated. The links between input devices 74 and processor 62 can be wired or wireless.

Referring specifically to keyboard 74-1, it should be understood that QWERTY or reduced keyboards are contemplated. Also, it should be understood that touchscreen 74-4 is implemented as a membrane or the like overlaid upon display 54. Remote control 74-5 can be a television remote control, or a wireless remote control game controller as currently used on Wii™ video game consoles from Nintendo™.

In sum the configuration of apparatus 58 can vary and depend on the type of platform used to implement system 50.

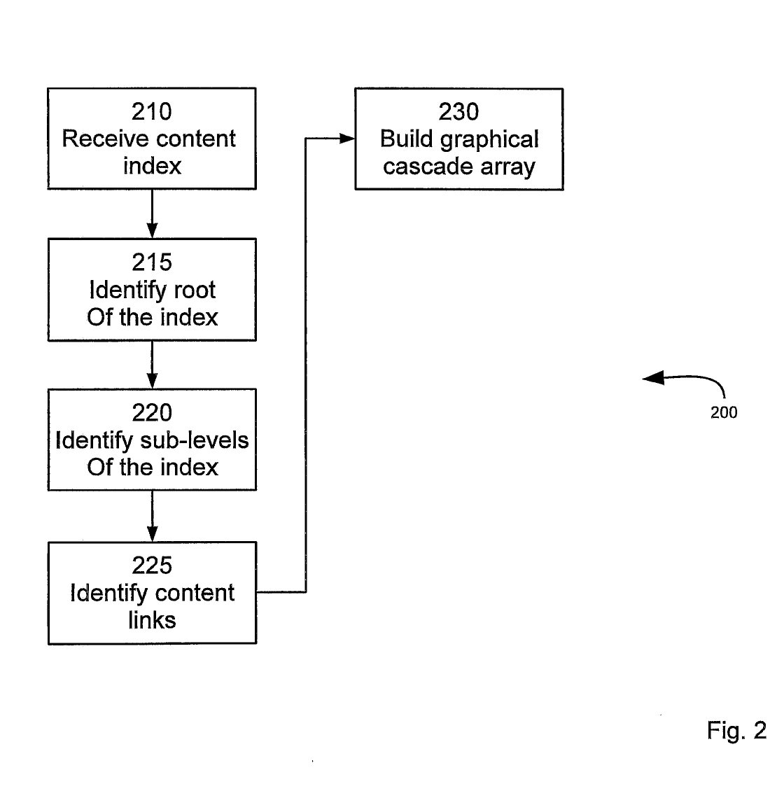

Referring now to FIG. 2, a computer-based method for building a data representation of a graphical cascade array is depicted in the form of a flow-chart and indicated generally at 200. Method 200 can be explained using system 50, but it will be understood that method 300 can be implemented on variations of system 50.

Block 210 comprises receiving a content index. Such a content index, in system 50, is received at processor 62. The format in which the content index is received, and the source thereof, is not particularly limited. In one contemplated implementation, method 200 is applied to indexing of media content which can comprise, without limitation, photos, movies, books and music. Other type of content is contemplated, including electronic magazines, electronic news papers, blogs, web pages, and even software applications. In general, any type of content that can be generated on a display of a computer is contemplated. For purposes of further discussion, content is focused on photos, movies, books and music, but it is to be emphasized these are just examples for illustration purposes.

It will now be apparent that the source of the content index can be locally developed by processor 62 based on an identification of actual content, or the content index can be created elsewhere.

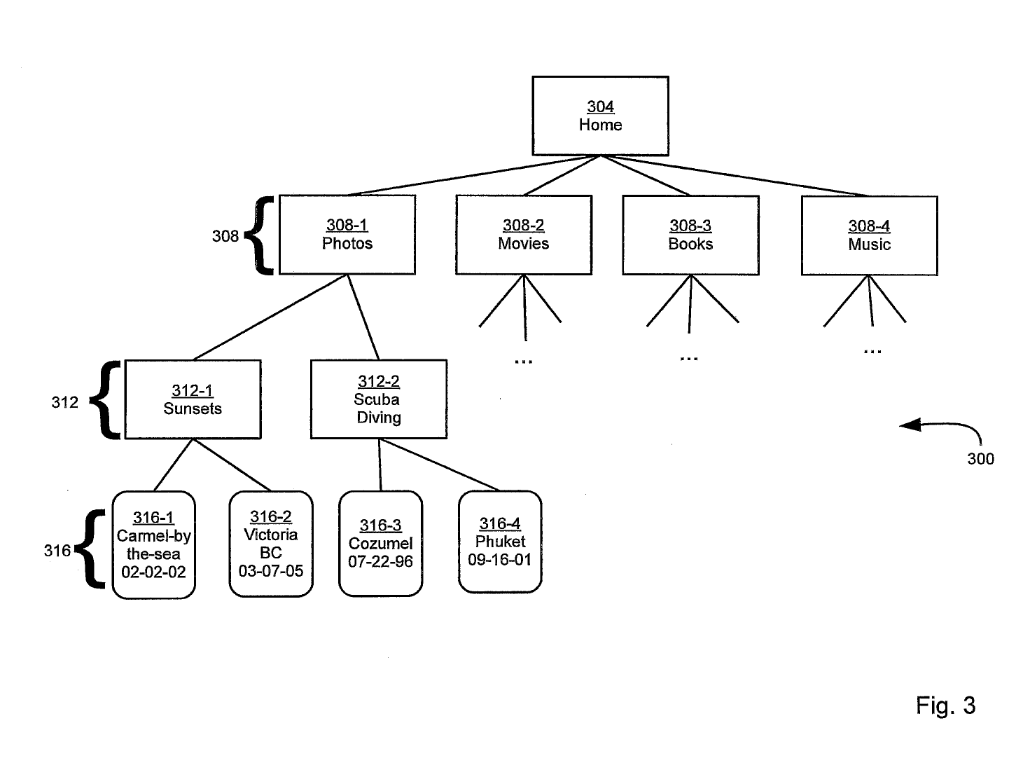

FIG. 3 shows a non-limiting example of a content index 300 that can be received at block 210. Content index 300 is represented in the form of a tree, which itself is readily representable as electronic data as a table or other data structure, but in any event this is a non-limiting illustrative example of how a content index may be represented.

Block 215 comprises identifying a root of the content index received at block 210. Often the root of the content index is inherent within the data structure and accordingly block 215 comprises examining the data content index 300 to ascertain the root. In data content index 300, the root is labeled as home 304.

Block 220 comprises identifying sub-levels of the content index received at block 210. Again, often the sub-levels of the content index received at block 210 are inherent within the data structure and accordingly block 220 comprises examining data content index 300 to ascertain the various sub-levels. Also as part of block 220, the number of sub-levels will also be ascertained.

In content index 300, two sublevels are present: the first sub-level is sublevel 308 and the second sub-level is sublevel 308. First sub-level 308 comprises photos 308-1, movies 308-2, books 308-3, and music 308-4. Accordingly first sub-level 308 identifies broad classes of types of media that are indexed by content index 300. Second sub-level 312 comprises sunsets 312-1 and scuba diving 312-2, which are particular folders or groupings of photographs. Accordingly, second sub-level 312 identifies logical groupings within the broader classes of media types. The specific example in FIG. 3 shows sunsets 312-1 and scuba diving 312-2 as depending from photos 308-1. While sub-level 312 is only shown as having specific examples beneath photos 308-1, it is to be understood that it is contemplated that each of movies 308-2, books 308-3, and music 308-4 also typically have their own second sub-level of logical groupings. For example, under movies 308-2, groupings can comprise genre (e.g. Western, Action, Drama, Documentary), actor (e.g. Meryl Streep; Daniel Day Lewis) etc. The same is also true for books 308-3 and movies 308-4. Specific examples of those are omitted for illustrative convenience.

Block 225 comprises identifying content links within the content index received at block 310. Such content links are also typically inherently ascertainable within the data structure of the particular content index, as such content links do not themselves point to another location in the index, but instead point to a content source external from the index. Note in variations, it is contemplated that the actual content may also be placed in the index, but this is not the present typically contemplated implementation.

In content index 300, the content links are labeled generally as 316. Specific example content links 316 are labeled as Carmel-by-the-sea 316-1, Victoria BC 316-2, which depend from Sunsets 312-1, and Cozumel 316-3 and Phuket 316-4 which depends from Scuba Diving 312-2. For illustrative convenience, the actual content links 316 specifically point to data files within content 82. However, it is to be understood that content 82 need not be maintained within any single source or location, and can in fact be distributed across the Internet or other network topology. Thus, content links may, by way of non-limiting example, be uniform resource locators (URLs) that point to specific web-content. Other forms of content links will now occur to those skilled in the art. In general, it should be understood that the form, structure, number of levels, number of links and other aspects of the content index are not particularly limited.

Block 230 comprises building a graphical cascade array based on the processing performed at the previous blocks. In the example implementation of system 50, the resulting graphical cascade corresponds to graphical cascade 78 and its creation will be discussed further below.

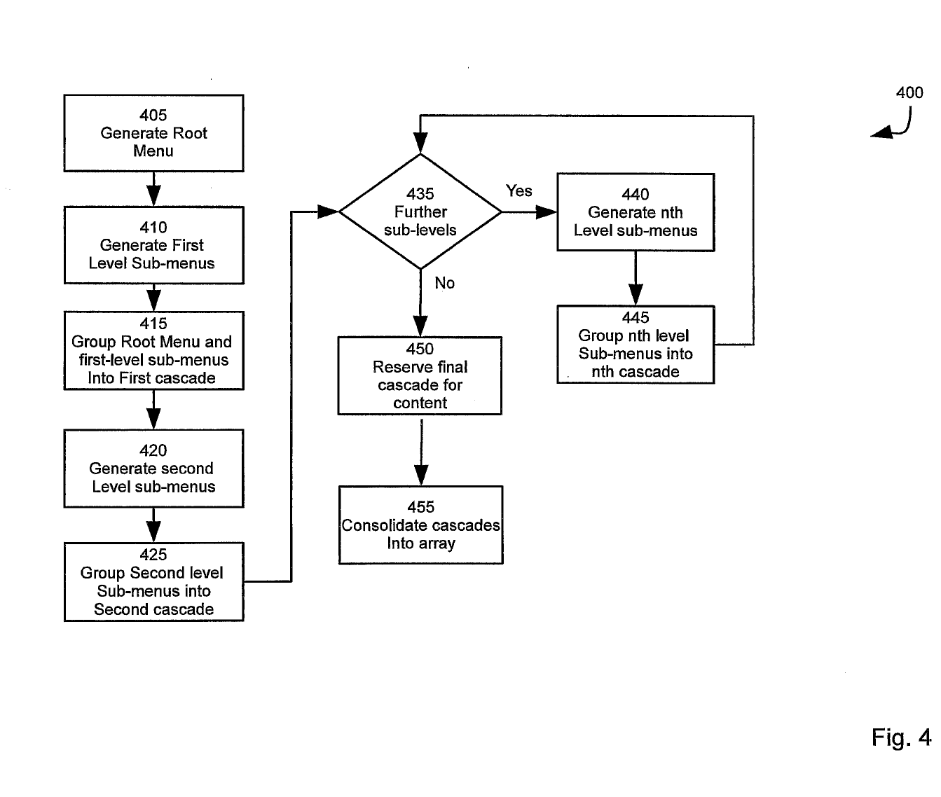

FIG. 4 and method 400 shows a flow-chart showing a specific example of how block 230 can be implemented. Example method 400 is based on a present implementation where the content index comprises at least two sub-levels (such as content index 300 which includes first sub-level 308 and second sub-level 312), but in variations it is contemplated that method 400 can be varied to accommodate only a single sub-level, whereby the first sub-level below the root of the content index points directly to content.

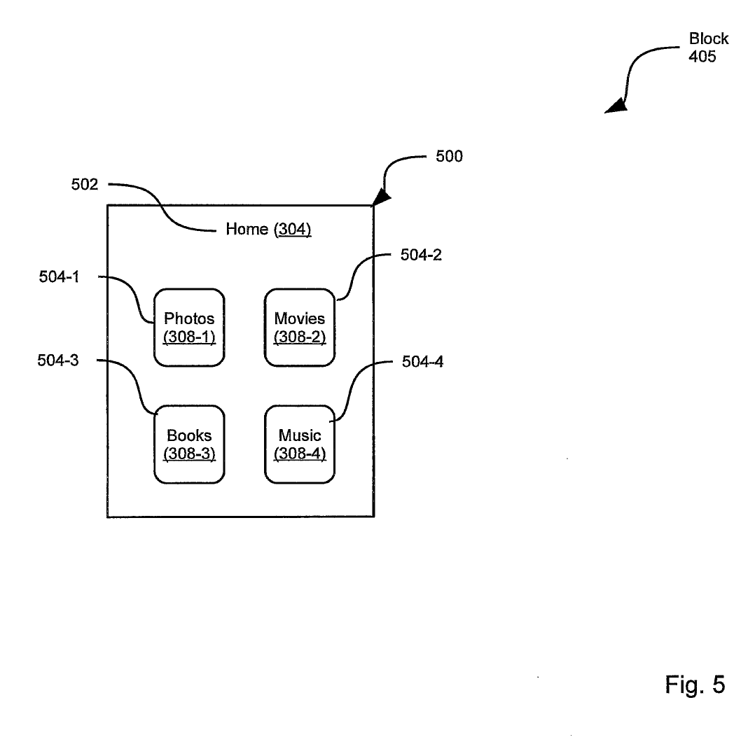

Block 405 comprises generating a root menu based on the results of block 215 and part of the results of block 220. More particularly, a root menu is generated at block 405 to create a menu of choices based on the headings within each first sub-level 308. Exemplary performance of block 405 is shown in FIG. 5 where a graphical representation of a root menu is indicated at 500. Root menu 500, upon creation, may be saved as a datafile within persistent storage 66 for subsequent generation on display 54 under the control of processor 62, or it may be dynamically generated on display 54 according to subsequent methods described below.

As seen in FIG. 5, root menu 500 thus comprises a ‘Home’ label 502 that corresponds to home 304 from content index 300. Root menu 500 also comprises a plurality of selectable icons 504 that correspond to photos 308-1, movies 308-2, books 308-3 and music 308-4. Note that references 304, 308-1, 308-2, 308-3 and 308-4 are shown in rounded brackets “( )” in FIG. 5 to denote that those references are not actually part of the root menu itself, but instead denote the relationship of a corresponding icon 504 back to its counterpart in content index 300. This use of brackets is used in subsequent figures to likewise indicate relationships back to content index 300, but such reference characters within those brackets are not necessarily actually generated within the root menu 500 or the other menus discussed below.

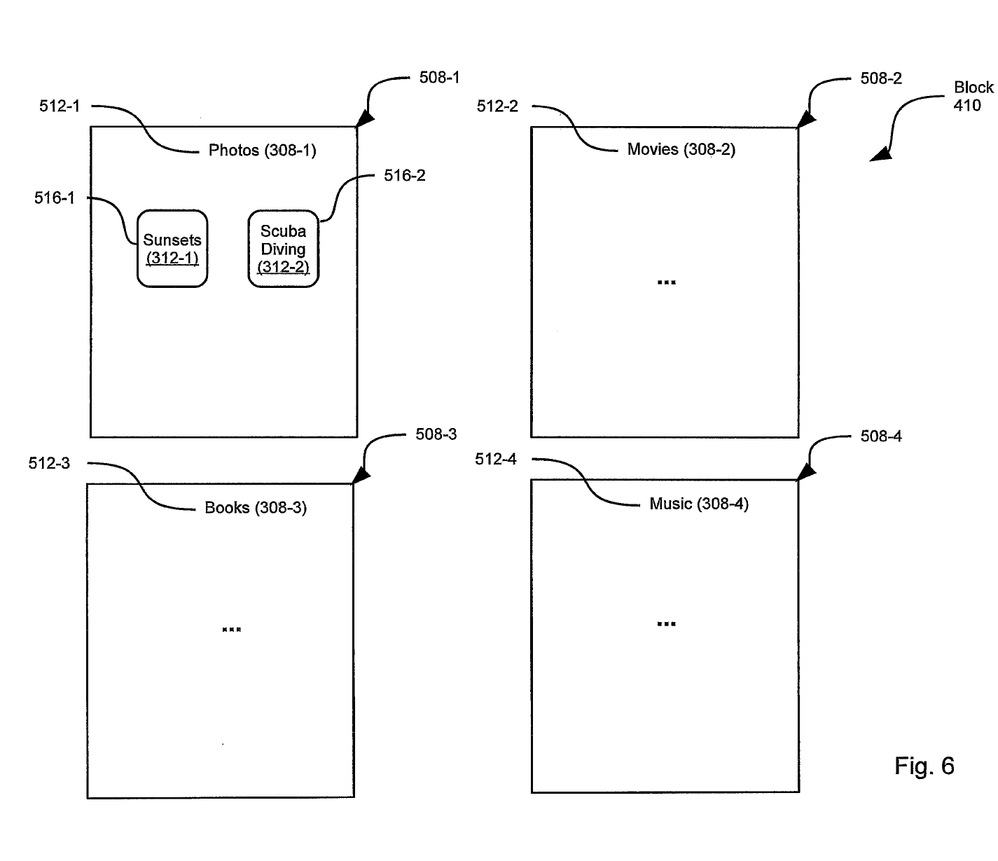

Block 410 comprises generating one or more first sub-level menus based on the results of block 220. More particularly, one or more first sub-level menus are generated to create, for each sub-level, a menu specific to that sub-level. Exemplary performance of block 410 is shown in FIG. 6, where a graphical representation of a plurality of sub-menus is shown, each indicated at 508. More specifically, a photos menu 508-1, movies menu 508-2, a books menu 508-3 and a music menu 508-4 are each created. Sub-menus 508, upon creation, are saved as data files within persistent storage 66 for subsequent generation on display 54 under the control of processor 62 or sub-menus 508 may be dynamically generated on display 54 according to subsequent methods described below.

As seen in FIG. 6, each sub-menu 508 thus comprises its own label 512 that corresponds to a respective node in the first-sub level 308 from content index 300. More specifically, a ‘Photos’ label 512-1, a ‘Movies’ label 512-2, a ‘Books’ label 512-3, and a ‘Music’ label 512-4 are each created to appear at the top of its respective sub-menu 508. Each sub-menu 508 also comprises a plurality of selectable icons 516 that correspond to respective nodes in the second sub-level 308. Note that references 308-1, 308-2, 308-3, 308-4, 312-1 and 312-2 are shown in rounded brackets “Q” in FIG. 6 to denote that those references are not actually part of the respective sub-menu itself, but instead denote the relationship of a corresponding label 512 and icon 516 back to its counterpart in content index 300. This use of brackets is used in subsequent figures to likewise indicate relationships back to content index 300, but such reference characters within those brackets are not actually generated within the sub-menus 508 or the other menus discussed below.

Also note that, for illustrative convenience, only sub-menu 508-1 is shown as having specific exemplary icons 516, while sub-menu 508-2, sub-menu 508-3 and sub-menu 508-4 each have ellipsis (“ . . . ”), corresponding to the ellipsis used in FIG. 3, which represent the fact that other icons are typically present within each sub-menu.

Block 415 comprises grouping the root menu from block 405 and the first level sub-menus from block 410 into a first graphical cascade, the details of which will be explained further below.

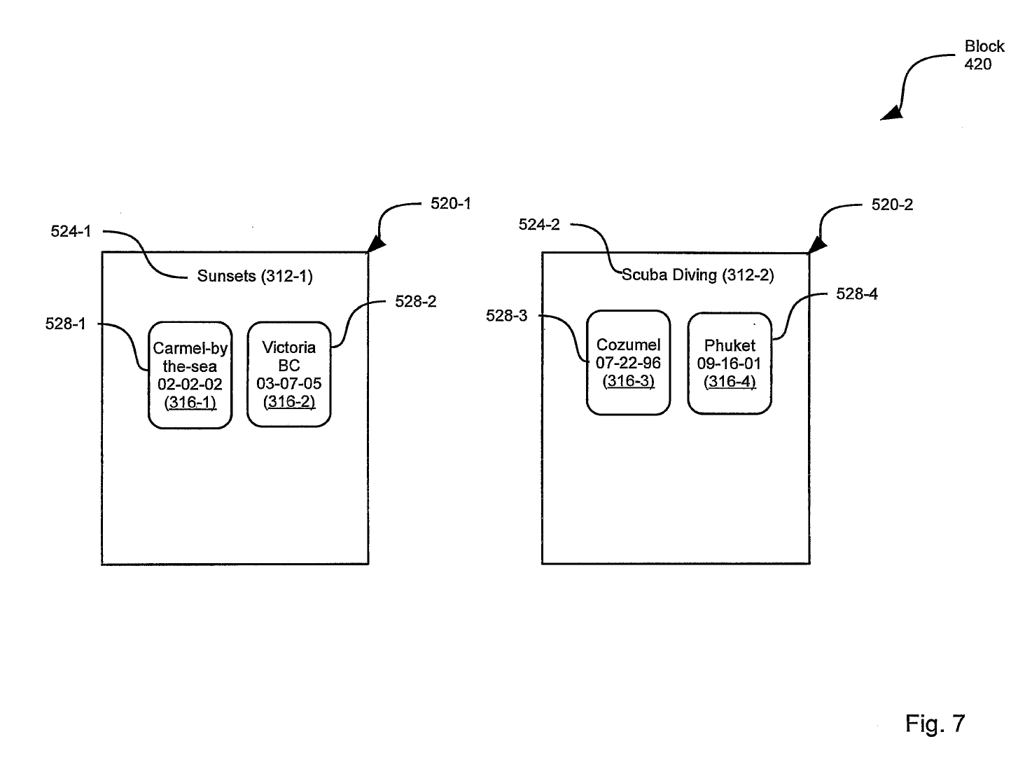

Block 420 thus comprises generating a second level of sub-menus, much in the same fashion as block 410. Exemplary performance of block 420 is shown in FIG. 7 which continues using the example content index 300 and shows the performance of block 420 as it relates to generation of menus 520 at second sub-level 312 to show respective content links 316.

As seen in FIG. 7, each sub-menu 520 thus comprises its own label 524 that corresponds to a respective node in the second-sub level 312 from content index 300. More specifically, a ‘Sunsets’ label 524-1 and a ‘Scuba Diving’ label 524-2 are each created to appear at the top of the respective ‘Sunsets’ sub-menu 520-1 and ‘Scuba Diving’ sub-menu 520-2. Each sub-menu 508 also comprises a plurality of selectable icons 516 that correspond to respective nodes in the second sub-level 308. Note that references 312-1, 312-2, 316-1, 316-2, 316-3 and 316-4 are shown in rounded brackets “Q” in FIG. 7 to denote that those references are not actually part of the respective sub-menu itself, but instead denote the relationship of a corresponding label 524 and icon 528 back to its counterpart it content index 300. This use of brackets is used in subsequent figures to likewise indicate relationships back to content index 300, but such reference characters within those brackets are not actually generated within the sub-menus 508 or the other menus discussed below.

Block 425 comprises grouping the second level sub-menus into a second graphical cascade, the details for which will be explained further below.

Block 435 comprises determining if there are further sub-levels within the content index, and if a “yes” determination is made, then block 440 is invoked which generates further sub-level menus in substantially the same fashion as block 420, and those further sub-level menus are grouped at block 445 in substantially the same fashion as block 445. Note that the example content index 300 does not include further sub-levels and so, in the example relating to content index 300, a ‘no’ determination is reached at block 435.

It should now be understood that in variations, block 415 can advance directly to block 435 and thereby obviate block 420 and block 425. In other variations, where a number of levels for a given content index are fixed, then method 400 can be varied to specifically accommodate content indexes of such fixed depth.

Block 450 comprises reserving a final cascade for actual generation of content that corresponds to content links 316, the details of which will be explained further below. Block 455 comprises consolidating cascades into an array.

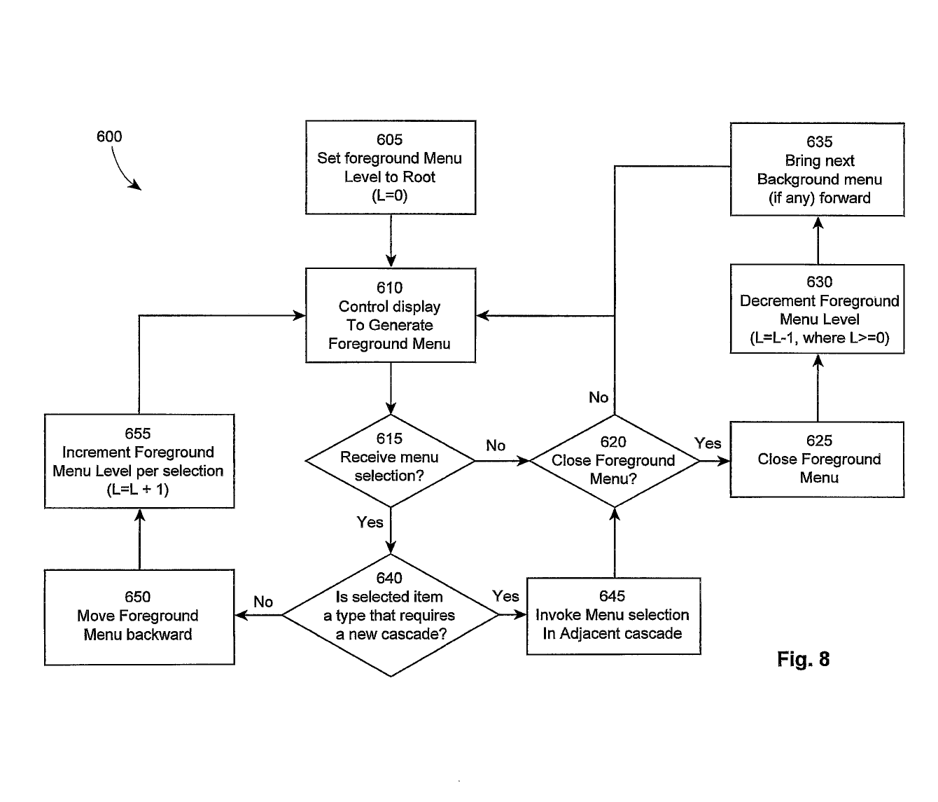

Referring now to FIG. 8, a method for controlling a display to provide content navigation is indicated generally at 600. Method 600 can be performed based on prior performance of method 200 and method 400 or variations thereon, and for purposes of illustration, it will be assumed that method 600 is performed continuing the foregoing example in relation to content index 300. However, it is to be emphasized that prior performance of method 200 or method 400 is not required, as other methods of generating the menus referenced in method 600 are contemplated and, with the benefit of the teachings herein, will be apparent to those skilled in the art.

Block 605 comprises setting a foreground menu level to a root menu level. Block 610 comprises controlling a display to generate a current foreground menu level. When block 610 is invoked directly after block 605, block 610 results in generation of a root menu as the foreground menu.

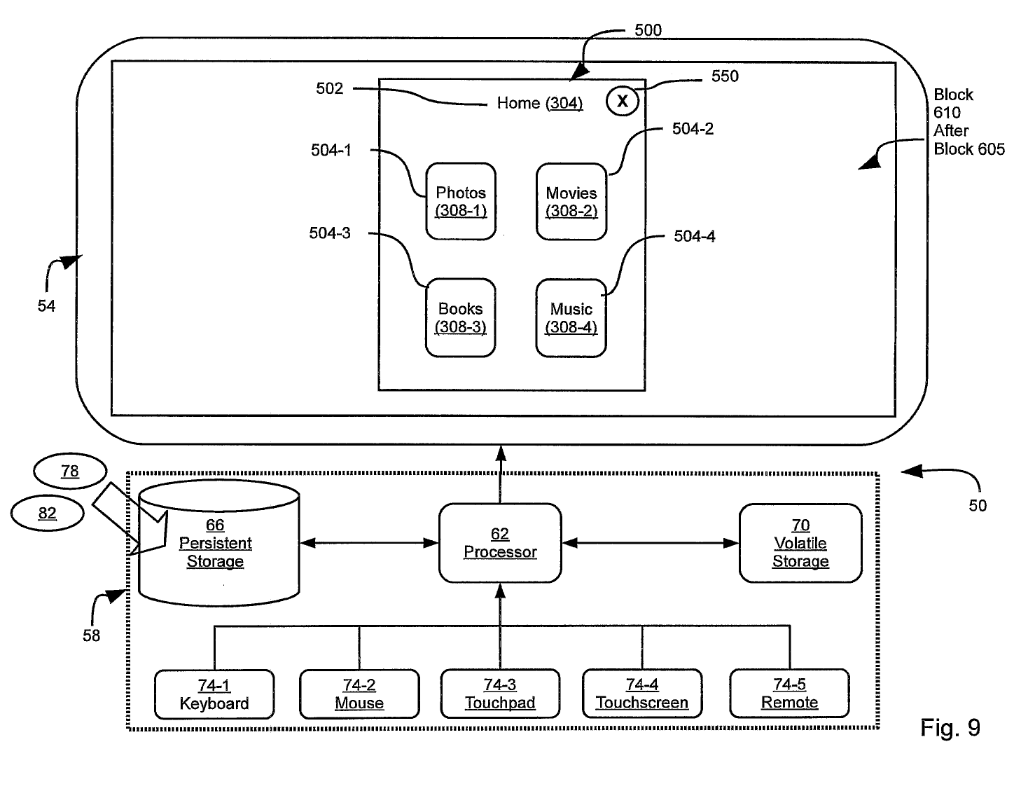

Exemplary performance of block 610, directly after performance of block 605, is represented in FIG. 9, where processor 62 is shown controlling display 54 to generate root menu 500 on display 54.

Referring again to FIG. 8, block 615 comprises determining if a menu item is selected. In system 50, block 615 is effected by processor 62 waiting for input from an input device 74 that corresponds to a selection of one of icons 504. The means by which such selection is made is not particularly limited and generally corresponds to the functionality of the particular input device 74. For example, via touchscreen 74-4, a selection of an icon 504 is effected by simply touching a location on display 54 that corresponds to a particular icon. Via mouse 74-2, a pointer on display 54 can be moved to hover over a desired icon. Via keyboard 74-1, cursor keys can be moved to highlight a desired icon.

A “no” determination at block 615 leads to block 620, where a determination is made as to whether input has been received requesting closure of the current foreground menu. A “yes” determination from block 615 will be discussed further below.

Again, the means by which an instructions to close the current foreground menu at block 620 is made is not particularly limited and generally corresponds to the functionality of the particular input device 74. For example, the encircled X icon 550 located in the top right corner of menu 500 may be selected which represents an instruction to close the current foreground menu. A “yes” determination from block 620 will be discussed further below, although in passing it will be noted that in a present embodiment, an attempt to close root menu 500 will lead to regeneration of the root menu at block 610 (via block 625, block 630 and block 635), but this regeneration not required. For example, closure of root menu 500 could lead to closure of an application that is associated with method 600 and thereby terminate method 600.

A “no” determination from block 615 leading to block 620, and a “no' determination from block 620 leading to block 610, results in no change occurring on display 54.

Returning again to block 615, a “yes” determination at block 615 leads to block 640. Such a “yes” determination is made when any of the menu items, in the form of icons 504, are selected via an input device 74.

Block 640 comprises determining if the item selected from the menu is of a type that leads to creation of a new cascade. A “yes” determination leads to block 645, in which case the current menu selection results in invocation of the menu selection in an adjacent cascade. Block 645 will be discussed further below.

In the present example in relation to content index 300, the content links 316 are menu items of a type that lead to creating of a new cascade. However, it will be appreciated that there may be other criteria for identifying menu items whose selection leads to creation of a new cascade. Preferably, there is metadata associated with each menu item that indicates whether selection of a particular menu item will lead to invocation of the menu selection in another cascade, or in the current cascade.

In a variation, it is possible to configure the menu items so that any item positioned in the index more than X levels below the root menu will be invoked in a new cascade, with X being a selectable, and preferably changeable, number.

Accordingly, assume that, as per FIG. 8, icon 504-1 is selected from root menu at block 615, which in turn results in a “yes” determination at block 615, and a “no” determination at block 640 leading to block 650.

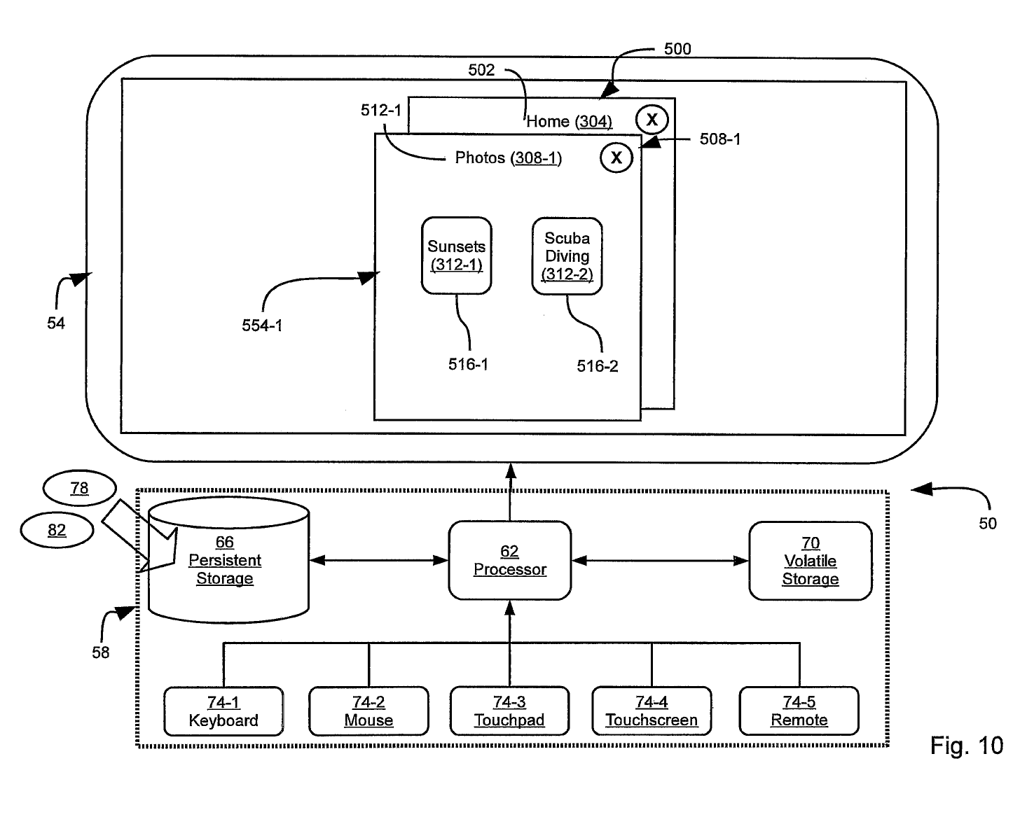

Block 650 comprises moving the current foreground menu backwards. In this example, root menu 500 is moved from the foreground into the background, as shown in FIG. 10. Block 655 comprises incrementing the foreground level to correspond with the menu selection received at block 615.

In this specification, “background” means a position in which the menu is visible on the display but is shown behind another object also visible on the display. “Foreground” means a position in which the menu is visible on the display 54 and is not shown behind another object also visible on the display.

In this non-limiting illustrative example, it is assumed that photos icon 504-1 corresponding to photos is selected and thus at block 655 the foreground level is incremented by one to correspond with the menu 508-1. From block 655 method 600 returns to block 610, and this exemplary performance of block 610 is shown in FIG. 10, whereby photos sub-menu 508-1 is shown in the foreground while the home menu 500 is shown in the background.

From the view in FIG. 10, if input is received to close the foreground menu (i.e. to close photos sub-menu 508-1) then block 625, block 630, and block 635 are invoked, which effectively reverse performance of block 650 and block 655 so that photos sub-menu 508-1 disappears and leaving root menu 500 in the foreground, returning the view on display 54 to the view shown in FIG. 9. Those skilled in the art will now appreciate that the depth of various foreground and background layer(s) may be elegantly generated on certain new three-dimensional (3D) versions of display 54, to give an appearance of actual depth.

Collectively, the foreground menu, which is a submenu of the background menu, together with the background menu itself, is referred to herein as a graphical cascade, which is indicated as 554-1 in FIG. 10. It is to be noted, and will become more apparent, that the view in FIG. 10 is a simplified graphical cascade which is useful for providing an illustrative introduction to the concept of graphical cascades.

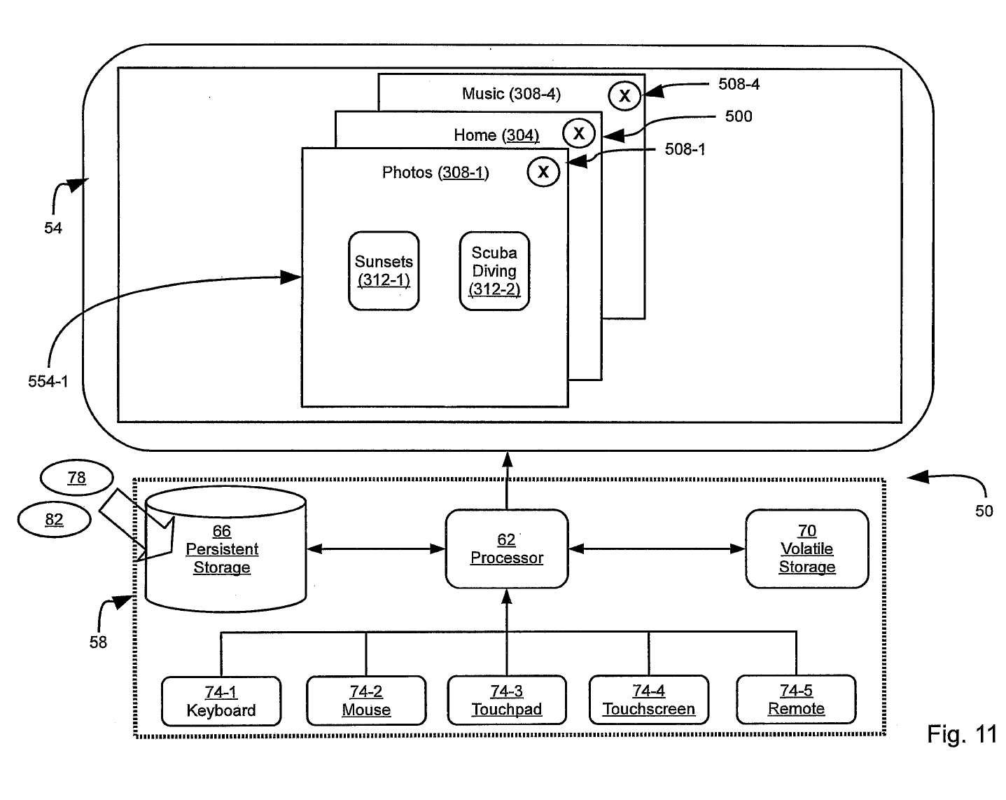

While not specifically illustrated in method 600, it is also contemplated that, in some implementations, the title bars of the background menus may remain active even while in the background, so that, for example, selection of home label 502 from the view in FIG. 10 will bring root menu 500 into the foreground and place photos sub-menu 512-1 into the background, and thereby permitting further selection of icons 504 from root menu 500 even while the photos sub-menu 512-1 remains visible in the background. An illustrative example of this graphical cascade is shown in FIG. 11, where music sub-menu 508-4 is the furthest in the background, the photos sub-menu 508-4 is in the foreground, and the root menu 500 is in the middle. The view in FIG. 11 can, for example, be reached from root menu 500 by first selecting the music icon 504-2 from root menu 500, to put root menu 500 in the background and putting the music sub-menu 508-4 in the foreground, then selecting home label 502 to bring root menu 500 into the foreground, and then selecting the photos icon 504-1 to invoke the photos sub-menu 508-1 into the foreground. By the same token, from FIG. 11, it is contemplated that music sub-menu 508-4 can be closed directly from the view in FIG. 11 thereby leading to the view shown in FIG. 10.

In the preferred embodiment, the system will incorporate both hierarchical graphical cascades, and order-of-selection graphical cascades. In a hierarchical cascade, the order of the menus, from root to foreground, always reflects the data hierarchy and the node within the data hierarchy where the user is. Thus, the scenario shown in FIG. 11 would not be possible in a hierarchical cascade, because the menus are out of order and do not reflect the data hierarchy. However, in an order of selection cascade, the menus may appear in the order they are selected by the user, without any necessary reference to the data hierarchy. In the embodiment described here, only the menus containing content links would typically appear in order of selection cascades. Other menus would typically be contained in hierarchical cascades, to allow for the efficient navigation that results from the user having a clear understanding of his position within the data hierarchy.

Returning now to FIG. 8 and method 600, when a “yes” determination is reached at block 640, then block 645 is invoked. In the example being discussed, in relation to content index 300, it was noted that content links are menu items of a type whose selection creates a new cascade, meaning that any selection from sub-menus 508 would result in a “yes” determination at block 640. It will be appreciated, however, that there is no necessary limit on the number of menus that can be opened in the first or parent cascade, and that where the next menu is displayed depends on the configuration of the system and the types of menus and menu items in the content index.

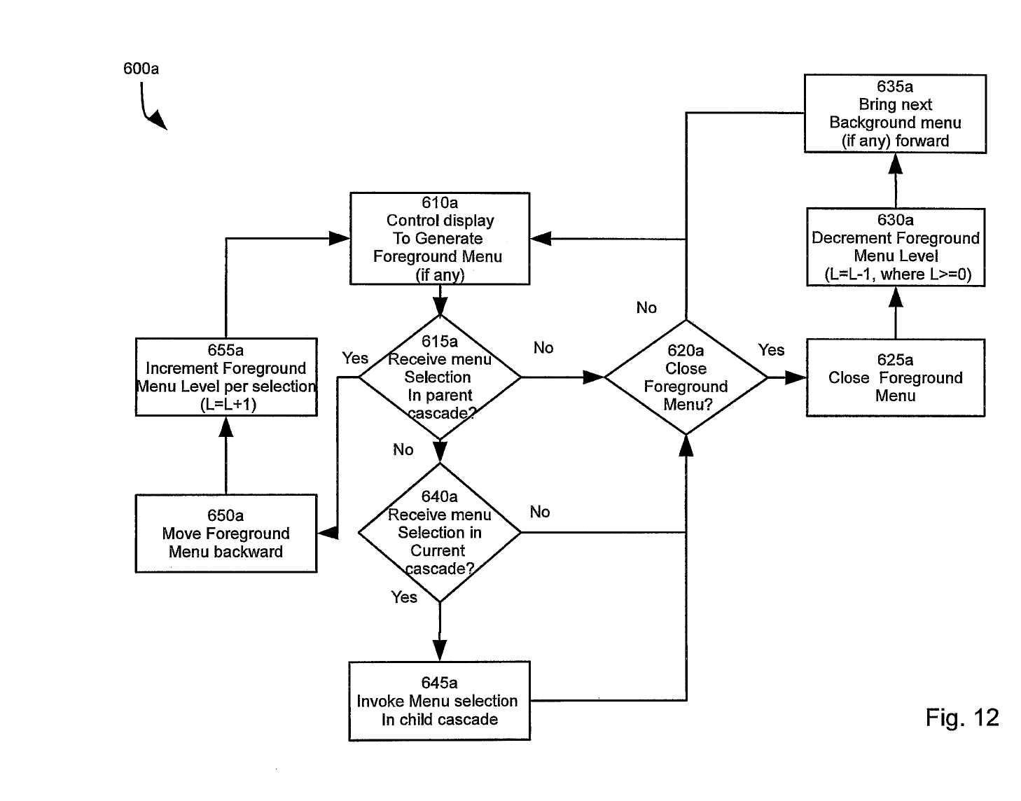

Invocation of block 645 results in generation of an adjacent cascade. The adjacent cascade can result in performance of its own unique instance of method 600 or a variation thereof. Method 600a in FIG. 12 shows such a variation of method 600, which can be used to manage and generate a child cascade from the first or parent cascade 554-1. In method 600a, like blocks bear like references to their counterparts in method 600, but followed by the suffix “a”. Method 600a omits block 605 relating to setting a root menu and in general method 600a does not contemplate management of root menu 500. Instead, sub-menus corresponding to the entirety of second sub-level 312 from content index 300 can be generated in the second graphical cascade 554-2 that is a child graphical cascade to graphical cascade 554-1. For clarity, the entirety of second sub-level 312 includes the possibility of generating (and selectively closing) one or more menus corresponding to sunsets 312-1 and scuba diving 312-2, and also of generating one or more menus that depend from movies 308-2, books 308-3 and music 308-4.

Of note is that in method 600a, block 615a contemplates reception of a menu selection from the parent graphical cascade 554-1. Such a menu selection in block 615a generally corresponds to a menu selection from the parent graphical cascade 554-1 that would result in invocation of block 645. A “yes” determination at block 615a leads to the addition of a new menu whereby the current foreground menu is moved to the background and the new menu is generated in the foreground.

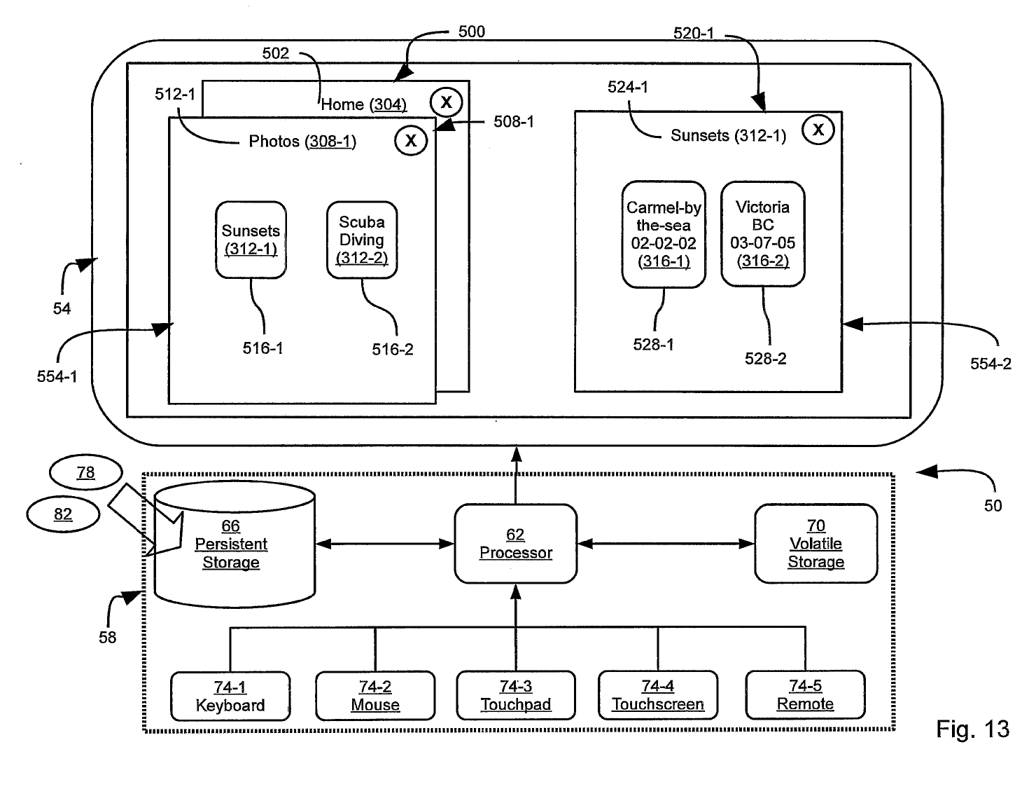

For illustrative purposes FIG. 13 shows the generation of sunsets menu 520-1 in a second graphical cascade 554-2, as a result of a selection of the sunsets icon 516-1 which thereby lead to invocation of block 645 and method 600a to result in generation of menu 520-1 in a position adjacent to the first graphical cascade 554-1. The view in FIG. 13 can generally correspond to the invocation of block 610a of method 600a from block 645 of method 600.

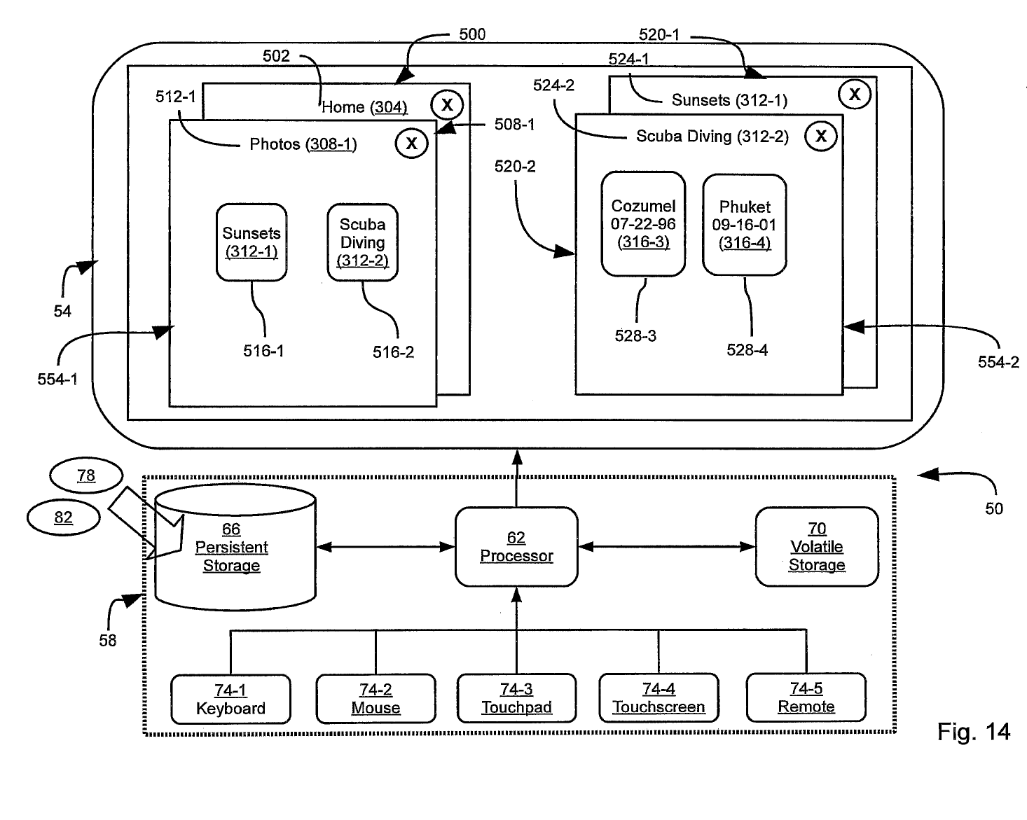

For further illustrative purposes FIG. 14 shows the generation of Scuba Diving menu 520-2 in the second graphical cascade 554-2 that was commenced in FIG. 13, as a result of a selection of the scuba diving icon 516-2 which thereby lead to invocation of block 645 and method 600a to result in generation of menu 520-2 in a position adjacent to the first graphical cascade while placing menu 520-1 in the background and placing menu 520-2 in the foreground. The generation of the view in FIG. 14 can generally correspond to the invocation of block 615a in method 600a from block 645 of method 600, and then invocation of block 650a and block 655a.

Means for further navigation within the second graphical cascade 554-2 will now be apparent. For example, closing the scuba diving menu 520-2 from FIG. 14 will return to generation of the view shown in FIG. 13. Such a transition from the view in FIG. 14 to the view in FIG. 13 can be effected by invocation of block 620a, block 625a, block 630a and block 635a.

Still further navigation from within the second graphical cascade can be effected by a yes determination at block 640a, whereby one of the icons 528 in the current foreground menu 520 is selected. For example, selection of icon 528-3 from menu 520-2 in FIG. 14 would lead to a ‘yes’ determination at block 640a.

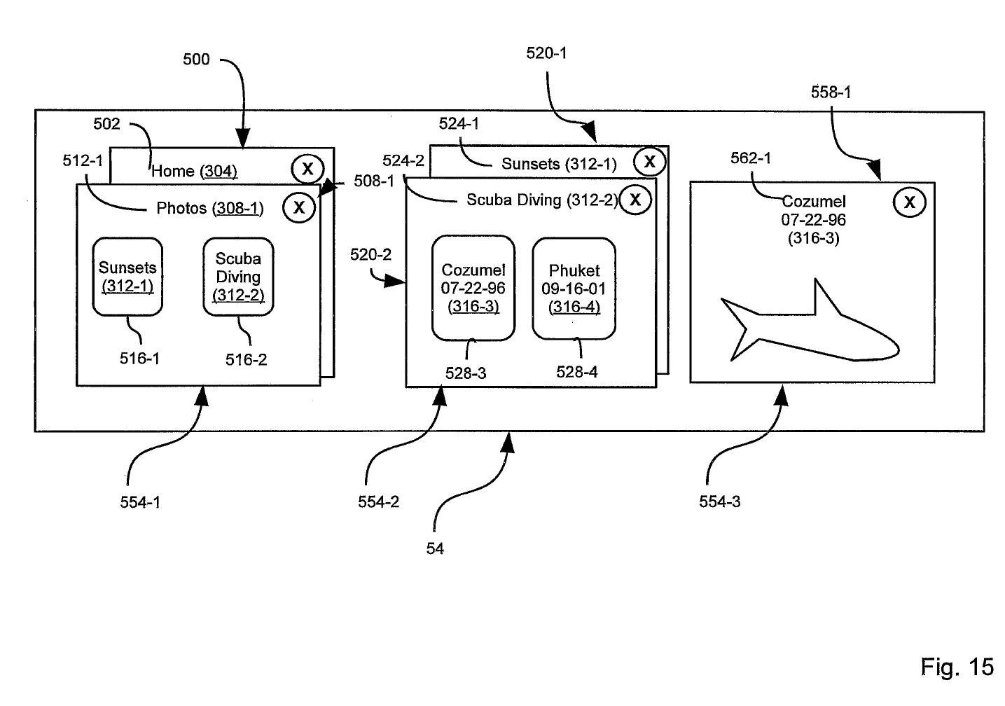

A ‘yes’ determination at block 640a leads to block 645a wherein a further child cascade is invoked. Referring now to FIG. 15, a third graphical cascade 554-3 (a child cascade of second graphical cascade 554-2) is shown on display 54. (For convenience, the other components of system 50 are omitted in FIG. 15). Third graphical cascade 554-3 is generated in conjunction with first graphical cascade 554-1 and second graphical cascade 554-2. Third graphical cascade 554-3, in FIG. 15, shows an exemplary result of selection of icon 528-3 corresponding to photographic content under scuba diving 312-2 and entitled “Cozumel 07-22-96” corresponding to Cozumel 316-3 from content index 300. Icon 528-3 thus results in activation of the content link associated with Cozumel 316, which in turn results in activation of third graphical cascade 554-3 as shown in FIG. 15.

Third graphical cascade 554-3 thus comprises a content window 558-1 that has a title bar 562-1 with the content “Cozumel 07-22-96”. Additionally, example content in the form of a photographic image of a shark is shown as generated within content window 558-1.

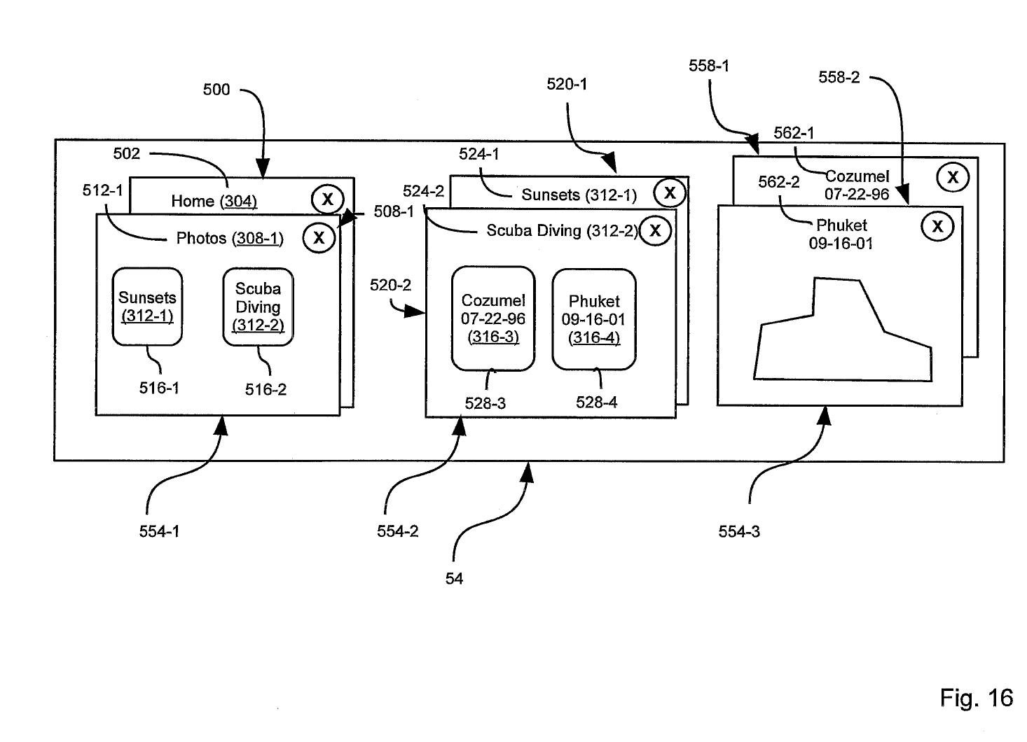

Exemplary further navigation using the foregoing techniques is shown in FIG. 16. In FIG. 16, which can be reached from the view in FIG. 15, icon 528-4 from graphical cascade 554-2 has been selected so that third graphical cascade 554-3 is updated to locate content window 558-1 in the background and generating a new foreground content window 558-2 that has a title bar 562-2 with the content “Phuket 09-16-01” (including a photographic image of a rock formation) that reflects Phuket 316-4 from content index 300.

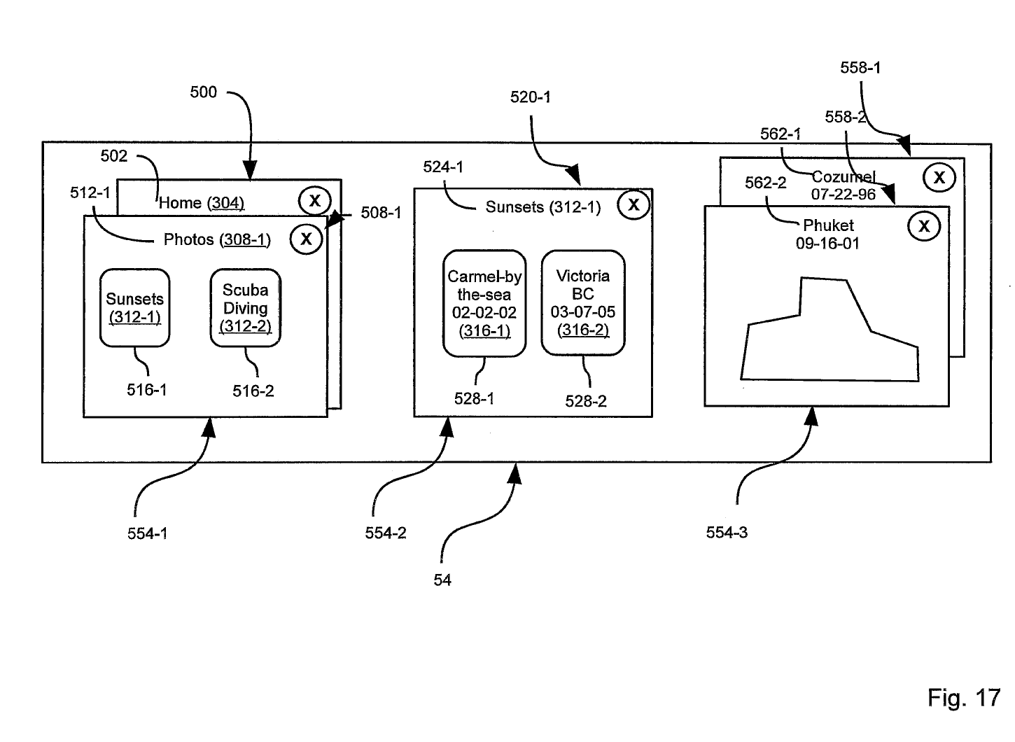

Exemplary further navigation using the foregoing techniques is shown in FIG. 17. In FIG. 17, which can be reached from the view in FIG. 16, menu 520-2 corresponding to Scuba Diving has been closed, thereby brining menu 520-1 into the foreground of graphical cascade 554-2. However, note that the cascade 554-1 and cascade 554-3 remain unchanged between the view in FIG. 16 and FIG. 17. FIG. 17 thus emphasizes that while invocation of a new menu or content window in a child cascade is effected from the parent graphical cascade, the closure of a menu or a content window in a child graphical cascade is effected through the child cascade and independent of activity in the parent graphical cascade. Thus, from the view in FIG. 17, content windows in third graphical cascade 554-3 corresponding to Carmel-by-the-sea 316-1 and Victoria BC 316-2 can be invoked without closing content window 558-1 or content window 558-2, but instead urging content window 558-1 and content window 558-2 into the background and augmenting the depth of third graphical cascade 554-3.

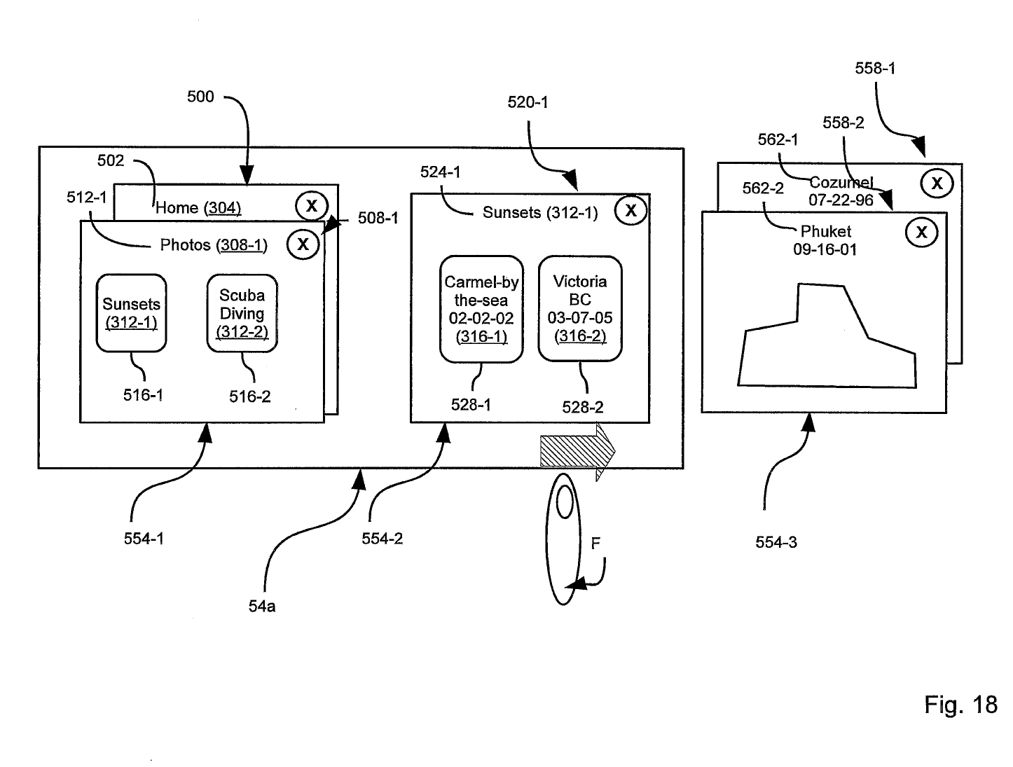

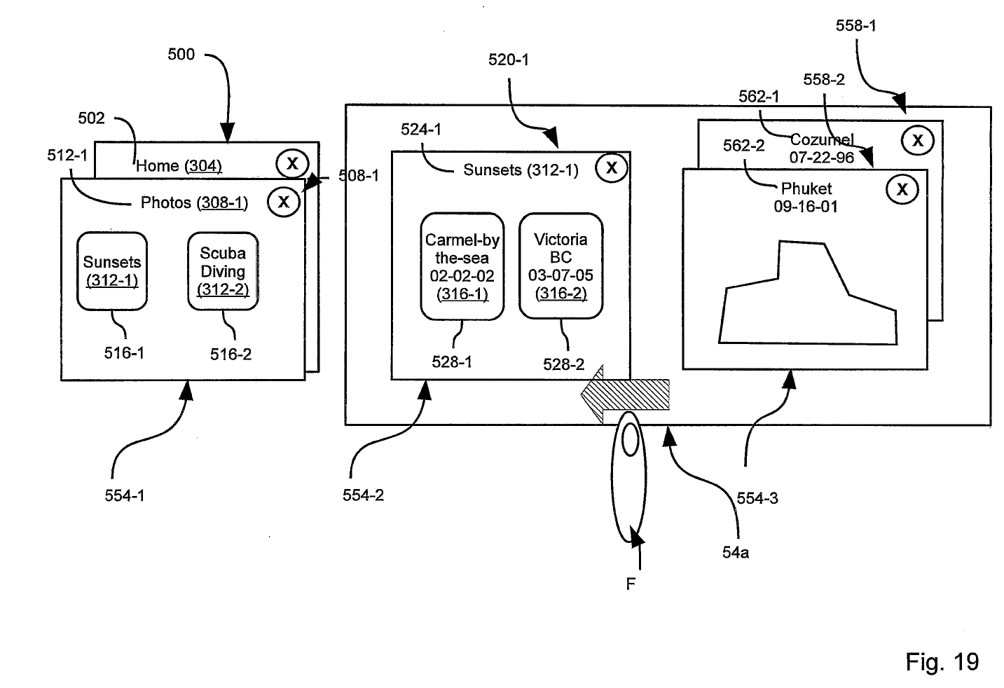

It is also contemplated that the graphical cascades 554 may be too wide for certain displays, in which case only one or two graphical cascades 554 may be shown at a time, with a navigation input instruction being reserved to scroll or pan between different graphical cascades. FIG. 18 and FIG. 19 shows such an example, whereby a modified display 54a, which is narrower than display 54, is shown. Display 54a is only wide enough to accommodate two graphical cascades at a time. In FIG. 18 graphical cascades 554-1 and 554-2 are generated on display 54a. In FIG. 19 graphical cascades 554-2 and 554-3 are generated on display 54a. Display 54a is configured to include a touch screen and to respond to horizontal swipe gestures (made, for example, with finger F). (Of course other types of input instructions can be used as well). A left-to-right swipe gesture changes display 54a from the view in FIG. 18 to the view in FIG. 19. A right-to-left swipe gesture changes display 54a from the view in FIG. 18 to the view in FIG. 19. Those skilled in the art will now appreciate that the teachings herein can be modified to accommodate displays that only fit a single graphical cascade 554. Those skilled in the art will also now appreciate that graphical cascades 554 can be configured in vertical rather than horizontal configurations. Those skilled in the art will also now appreciate that the graphical cascades 554 can be configured in grid configurations having both a vertical and a horizontal extent.

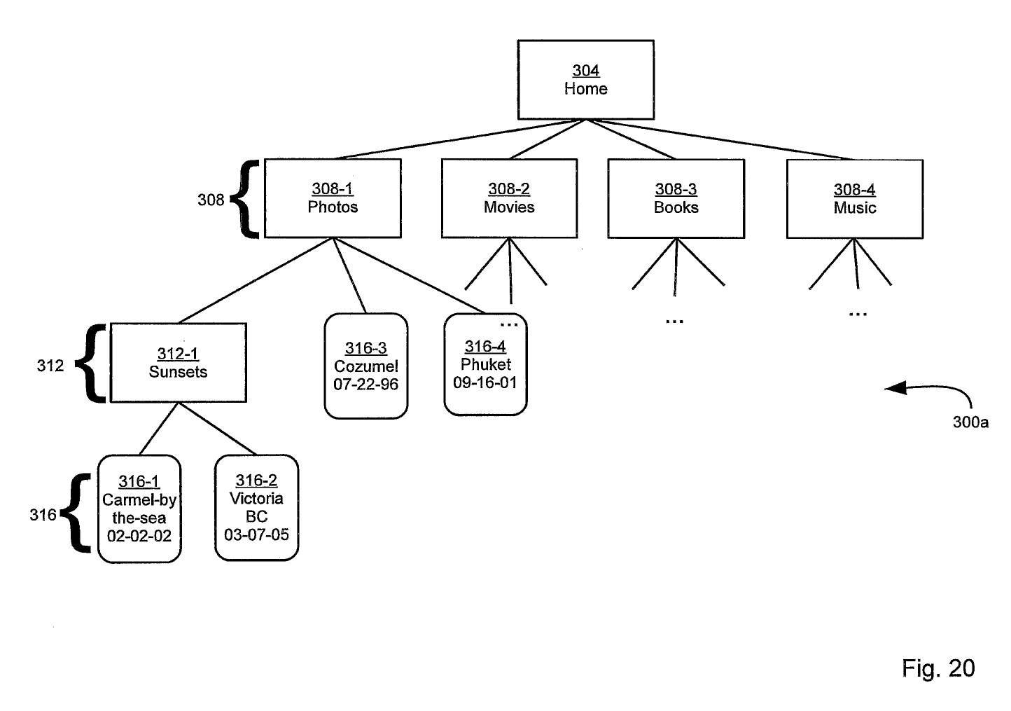

Further variations are contemplated. For example, it is contemplated that a content index such as content index 300 may include content links on the same level as sub-menus. An example is shown in FIG. 20 in the form of content index 300a. In this example, the content links 316-3 and 316-4 may appear in the same sub-menu as sunsets 312-1, but selection of such content links 316-3 or 316-4 will lead to direct invocation of third graphical cascade 554-3 directly from first graphical cascade 554-1.

As a still further variation, the graphical cascade 554 (e.g. graphical cascade 554-3) that generates content may be provided with further widgets, not shown. Such widgets can include, for example, means (an icon provided on display 54, or accessible on display 54 by minimizing one or more of graphical cascades 54) to directly manipulate the collection of content windows in the graphical cascade 554. Such manipulation can include publishing all of the content windows to a social network site, or emailing all of the content windows, or adding the content windows, in bulk to a favorites folder. Such widgets may also include a means to instruct interaction between various content windows 558. For example one content window may be populated with a plain text search string (e.g. Pizza parlours in Toronto, Ontario), which is then automatically entered into a search field in a plurality of cascaded content windows 558 that contain mapping search engines (e.g. Google Maps™ can be active in one content window 558; Bing™ from Microsoft™ may be active in a second content window; Mapquest™ may be active in another content window 558). The searches then would run in each content window 558 substantially in parallel and the results would be available by navigating through each content window 558. Advantageously, entering the search string multiple times into each content window 558 is obviated.

Note also that the general functionality discussed in relation to FIG. 11 (i.e. the ability to directly navigate between root menu 500, and sub-menus 508 within cascade 554-1) can also be applied to other cascades 554. For example, the functionality in FIG. 11 can be modified to be applied to sub-menus 520 within cascade 554-2 so that navigation may be effected between sub-menus 520 within cascade 554-2. Likewise, the provision of direct navigation between various content windows 558 within cascade 554-3 is also contemplated. Finally, while the functionality in FIG. 11 can be provided in all of the cascades 554, note also that, in a present commercial implementation, to improve usability, it may be preferred to limit the first cascade 554-1 to only providing a root menu 500 and a single sub-menu 508.

It should be emphasized that the actual content shown in the content graphical cascade (e.g. graphical cascade 554-3) is not limited to any particular type of content, and that heterogeneous forms of content may appear in different content windows within the cascade. The cascade can, for example, have a movie, a web page, an eBook, and a photograph all simultaneously open within the graphical cascade.

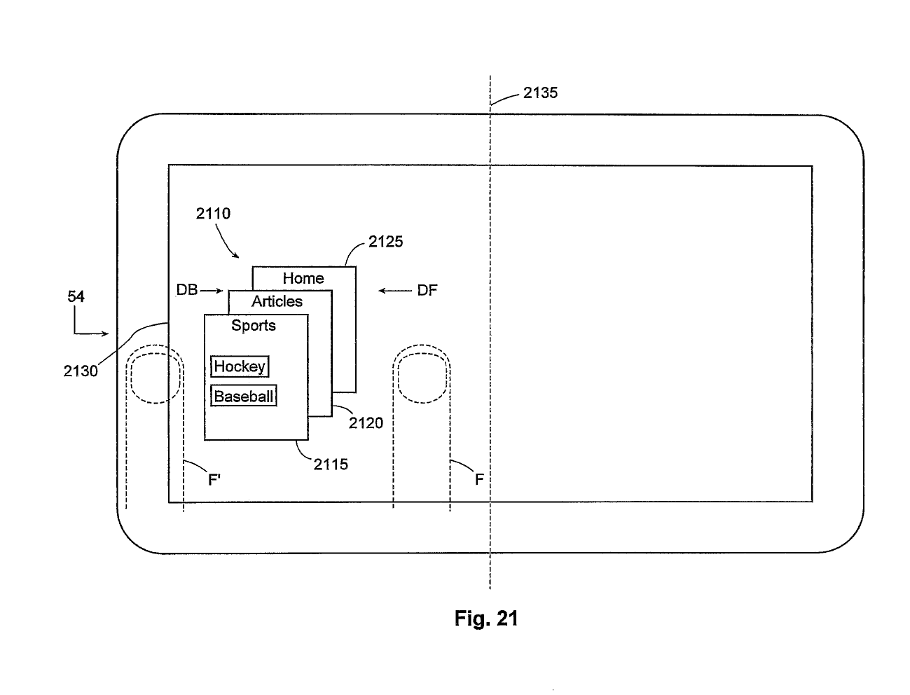

The system is further configured to permit navigation through individual graphical cascades by a preferred means other than closing foreground menus and selecting menu items to open new menus. Referring now to FIG. 21, a display 54 is shown displaying a cascade 2110. Example graphical cascade 2110 has three menus 2115, 2120 and 2125, with menu 2115 shown in the foreground, menu 2120 shown in the background immediately behind menu 2115, and menu 2125 shown in the background immediately behind menu 2120. In this example, only these three menus have been generated in cascade 2110. Also in this example, cascade 2110 is positioned on the left side of display 54.

In the preferred method, the user may navigate cascade 2110 by swiping display 54 (which is a touchscreen), most preferably using either a leftward (i.e. right to left) swipe, or a rightward (i.e. left to right) swipe. Typically, to navigate forward (i.e. toward the root menu), the swipe will be from the vertical centre-line 2135 of display 54 toward the side edge 2130 of the display 54 closest to the cascade. Thus, in the case of cascade 2110, a right to left swipe would be used to navigate toward the root menu from the current foreground menu 2115. This direction is shown in FIG. 21 as DF, and finger F is shown in a ready position to wipe in the direction DF.

Typically, to navigate in the opposite direction in the cascade (i.e. backward, away from the root menu toward the menus closer to the foreground), an oppositely-directed swipe is used. In the case of cascade 2110 shown in FIG. 21, that would be a swipe from the side edge 2130 toward centre-line 2135, a left to right swipe. In FIG. 21, this direction is shown as DB, and finger F′ is shown in a ready position to swipe in direction DB. To navigate in a particular cascade, the user would swipe so as to touch the screen on or adjacent to that cascade, This becomes relevant when there is more than one cascade showing on display 54, because the point where the swiping finger touches the display will typically determine which display the user is navigating.

Thus, to navigate through a cascade that is positioned toward the right side of display 54, the swiping directions would be reversed, since navigating forward is done by swiping from the vertical centre-line of the display toward the side edge of the display nearest to the cascade. Thus, when the cascade is on the right side of the display, to navigate forward, a left to right swipe would be used, and to navigate backward, a right to left swipe would be used.

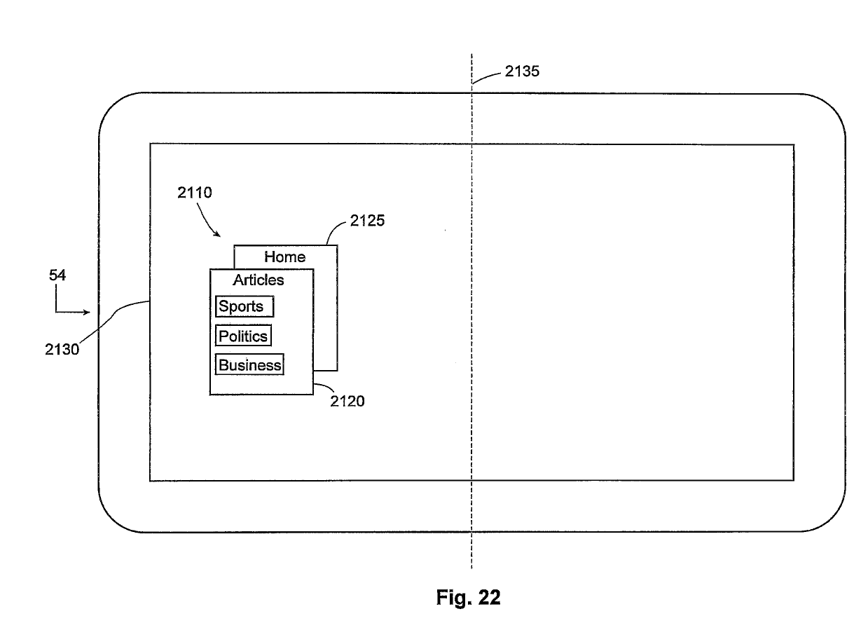

FIG. 22 shows the same cascade as in FIG. 21, but after a single right to left swipe has caused the user to navigate forward by one step. Thus, menu 2115, previously in the foreground of cascade 2110, is now not showing in cascade 2110. However, according to the preferred embodiment, menu 2115 is not closed. Rather, it continues to be in memory, and if the user were to swipe in the opposite direction, menu 2115 would reappear as in FIG. 21. Notionally, as with a stack, when the user navigates forward, he is removing the menu in the foreground from the top of the cascade or stack. Thus, in FIG. 22, menu 2115 is notionally hovering in front of and to the left of display 54, having been “removed” from stack or cascade 2110 by a right-to-left swipe. A left-to-right swipe would notionally push menu 2115 back onto the cascade/stack.

If the cascade 2110 were located to the right side of display 54, the directions would be reversed, but the notion is the same. A left to right swipe removes the foreground menu from the cascade/stack, so that it is notionally positioned in front of and to the right of the display 54. A right to left swipe would notionally push the same menu back onto the cascade/stack.

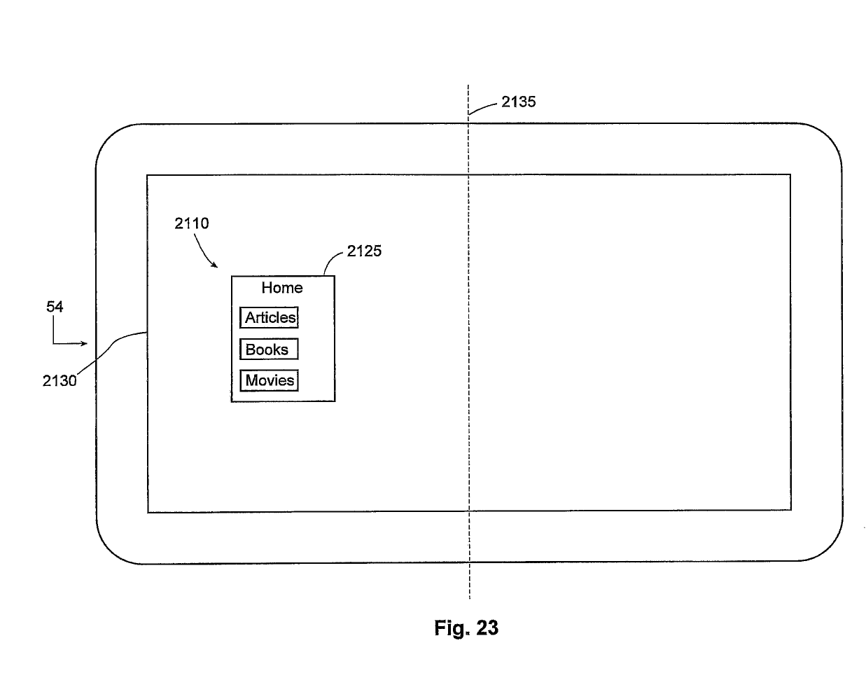

FIG. 23 shows the cascade 2110 after another navigation step forward (i.e. another swipe in direction DF). Menu 2120 has now been removed from the cascade 2119, hovering notionally outside the display 54 with menu 2125. If the user then chooses to navigate backwards through cascade 2110, he would swipe in direction DB, and menu 2115 would appear in the foreground of the cascade 2110, as in FIG. 22. Another swipe in the direction DB would cause menu 2125 to appear in the foreground of cascade 2110, as in FIG. 21. Thus, when navigating backwards, menus that were previously removed from the cascade 2110 by forward navigation reappear on the stack in reverse order of their previous removal.

Thus, in forward navigation, the menus are dealt with according to a last-on-first-off algorithm. The latest menu to come onto the cascade in the first one to come off as forward navigation occurs. In backward navigation, the menus are dealt with according to a last-off-first-on algorithm. The last menu to come off the cascade (during forward navigation) is the first one to come back onto the cascade.

Consider a case where the user navigates forward from FIG. 21 to FIG. 22 by removing sports menu 2115 from the cascade, and then selects “politics” (menu item 2140) from menu 2120. In such a case, a new menu entitled politics would open in cascade 2110. If cascade 2110 is a hierarchical cascade, then it is configured to always show the user where in the data hierarchy the user is located. Thus, if cascade 2110 is a hierarchical cascade, then sports menu 2115 would automatically close, and would no longer be in the cascade 2110. In accordance with the requirements of a hierarchical cascade, the cascade 2110 would show only a single path from the node at which the user is located to the topmost node in the hierarchy.

In this same case, however, if the relevant cascade were non-hierarchical (i.e. an order of selection cascade), then no menus would close automatically and all would remain in the cascade until closed directly user input.

It will be appreciated that variations are contemplated. For example, the display 54 could be configured to show two cascades, one atop the other, rather than the typical side-by-side configuration. In such a case, preferably, navigation forward could be done by a swipe from left to right on or adjacent to the cascade through which navigation is desired. To navigate backward, the user would preferably swipe from right to left on or adjacent to the cascade through which it is desired to navigate. This same method of navigation would preferably apply in a case where there is only one cascade in the approximate middle of the display 54. Other variations for swiping directions and navigation are possible, though it is believed that the method explicitly described herein is the most intuitive for the most users.

It will be appreciated by those skilled in the art that a number of the features of the preferred system 50 described herein provide benefits to users not found in previous systems. For example, in the preferred system 50, the cascades are shown with a three dimensional visual effect. Thus, the foreground menu is shown on the display 54, and the background menus are shown as being “behind” the foreground menu. Each background menu is shown as being slightly offset (typically to the right) from the menu in front of it, and the further into the background a menu is located, the smaller it appears. A cascade thus appears to be vanishing into the distance within the screen, and (typically) to the right. This three-dimensional effect, together with the navigation method described above, makes navigation easier and more intuitive. It is not necessary for a user to hunt with his mouse for the close button on each menu. Rather, with one swipe of his finger, a user can move forward or backward in a cascade, and because of the three dimensional visual effect, can have an intuitive feel for where he is going and where he has been. Navigation is also made easier by the fact that when there is more than one cascade on the display 54 at once, the cascades do not overlap, with the result that it is simple to navigate in one cascade without affecting the other.

As another example, the system 50 is configured so that when a menu item is selected, a corresponding new menu is automatically opened in the foreground of the cascade, or in an adjacent cascade, if appropriate. In other words, the user does not choose whether the new menu will be opened and shown in the foreground of a cascade—it happens automatically upon selection of a menu item. Similarly, when a new menu is opened in the foreground of a cascade, the menu previously in the foreground of that cascade is automatically moved to the background of that cascade. This feature is beneficial because it allows for faster opening of menus, and for better organization and easier navigation. Menu opening is faster because, if the user had a choice of whether to open a menu to the foreground of a cascade, or open it some other way, he would have to make that choice each time he selected a menu item, slowing down menu opening and navigation. As for better organization, the automatic opening of menus to the foreground of a cascade enforces the requirement, for hierarchical cascades, that the menu showing always matches the node within the data hierarchy where the user is presently located, and shows a single path to the root menu. The user, therefore, always knows where he is in the data hierarchy, and is therefore better able to get where he wants to go efficiently. As for easier navigation, if the user were allowed to choose how a new menu opened (including opening a new menu apart from any cascade), then in short order the user would find himself hunting around the display with his mouse pointer, trying to find a menu he opened previously whose location is not easily ascertainable because the user can't remember how or where he chose to open that menu.

Thus, with the automatic opening of new menus to the foreground of a cascade, navigation is easier and more organized. As described above, navigating one step forward or backward preferably requires only one finger swipe of the display 54, and efficient use of this navigation method is enabled by automatic opening of new menus so that they are shown in the foreground of a cascade.

The invention further comprehends (1) a computer readable medium containing computer-executable instructions to perform the methods described here; (2) a computer programmed with computer-executable code to perform the methods described here; (3) a system consisting of the aforementioned computer and a display operatively connected to one another to perform the method described herein.

It is to be understood that variations, sub-sets and combinations of the foregoing are contemplated, and that the scope of the exclusive privilege of this specification is defined by the claims.

1. A computer-implemented method of controlling a display to provide content navigation, comprising the steps of:
(a) controlling said display to activate a first graphical cascade to show a root menu in said first graphical cascade, said root menu comprising a first set of menu items;
(b) in response to a selection of one of the first set of menu items, controlling the display to (I) activate a second menu, corresponding to said one of the first set of menu items, so as to automatically show the second menu in a foreground of the first graphical cascade, and (II) automatically move the root menu so as to show the root menu in a background of the first graphical cascade; said second menu comprising a second set of menu items;
(c) in response to a selection of one of the second set of menu items, controlling said display to automatically activate a third menu in a second graphical cascade adjacent to said first graphical cascade, the third menu corresponding to the one of the second set of menu items, and comprising a third set of menu items.

2. A method as claimed in claim 1, the method further comprising the step of:
a. in response to a selection of another of the second set of menu items, controlling the display to (I) activate a fourth menu corresponding to said other of the second set of menu items, so as to automatically show the fourth menu in a foreground of the second graphical cascade; and (II) automatically move the third menu to show the third menu in a background of the second graphical cascade; the fourth menu comprising a fourth set of menu items.

3. A method as claimed in claim 1, wherein the method further comprises the step of:
a. in response to a selection of one of the third set of menu items, automatically activating a third graphical cascade, including an activated content link corresponding to the one of the third set of menu items.

4. A computer-implemented method of controlling a display to provide content navigation, comprising the steps of:
(a) in response to a user selection, controlling said display to automatically activate a menu in a foreground of a first graphical cascade, said menu comprising a first set of menu items;
(b) in response to a selection of one of the first set of menu items, controlling the display to (I) activate a next menu, corresponding to said one of the first set of menu items, so as to automatically show the next menu in a foreground of the first graphical cascade, and (II) automatically move the menu so as to show the menu in a background of the first graphical cascade; said next menu comprising a second set of menu items;
(c) in response to a selection of one of the second set of menu items, controlling said display to automatically activate a further menu in a second graphical cascade adjacent to said first graphical cascade, the further menu corresponding to the one of the second set of menu items, and comprising a third set of menu items.

5. A method as claimed in claim 4, the method further comprising the step of: in response to a selection of another of the second set of menu items, controlling the display to (I) activate an additional menu corresponding to said other of the second set of menu items, so as to automatically show the additional menu in a foreground of the second graphical cascade; and (II) automatically move the next menu to show the next menu in a background of the second graphical cascade; the additional menu comprising an additional set of menu items.

6. A method as claimed in claim 4, wherein the method further comprises the step of: in response to a selection of one of the third set of menu items, automatically activating a third graphical cascade, including an activated content link corresponding to the one of the third set of menu items.

7. A method as claimed in claim 4, wherein each menu item in said first set and said second set has associated therewith metadata identifying it as being in a first category of items the selection of which automatically activates a new menu in the graphical cascade in which said each menu item is located, or a second category of items the selection of which automatically activates a new menu in another graphical cascade.

8. A method as claimed in claim 7, further comprising the steps of (1) upon selection of said one of said first set of menu items, determining that said one of said first set of menu items is in the first category, and (2) upon selection of said one of said second set of menu items, determining that said one of said second set of menu items is in the second category.

9. A computer-implemented method of displaying a graphical cascade array, the method comprising the steps of:
(a) receiving a content index;
(b) identifying a root of the index;
(c) identifying sub-levels of the index;
(d) identifying content links in the index;
(e) building a graphical cascade array;
(f) using the array, displaying a graphical cascade, the graphical cascade including a plurality of menus, a root menu corresponding to a root of the index being shown in a background of the graphical cascade, and another menu corresponding to a node at a sublevel of the index being shown at a foreground of the graphical cascade.

10. A computer-implemented method for navigating within a graphical cascade, the graphical cascade comprising a plurality of menus in a stack, wherein a first one of the plurality of menus is shown in a foreground, and the rest of the plurality of menus are in the background, the graphical cascade being displayed on a touchscreen display, the method comprising the steps of:
(a) swiping the touchscreen on or near the cascade in a first direction to remove the first one of the plurality of menus from the display, and cause a next menu in the stack to be displayed in the foreground;
(b) swiping the touchscreen on or near the cascade in a first direction to remove the next menu from the display and cause a following menu in the stack to be displayed in the foreground.

11. A method as claimed in claim 10, the method further comprising the step of swiping the screen in a second direction on or near the cascade to return the next menu to the display and cause the next menu to be shown in the foreground.

12. A method as claimed in claim 11, the method further comprising the step of swiping the screen in a second direction on or near the cascade to return the first one of the plurality of menus to the display and cause the first one of the plurality of menus to be shown in the foreground.

13. A method as claimed in claim 10, wherein the graphical cascade is displayed adjacent to a first side edge of the touchscreen display, swiping the touchscreen in the first direction comprises swiping the touchscreen in a direction from the vertical centre-line of the display toward the first side edge, and swiping the touchscreen in the second direction comprises swiping the touchscreen in a direction from the first side edge toward the vertical centre-line of the display.

14. A method as claimed in claim 10, wherein the graphical cascade is displayed adjacent to one of a top edge or a bottom edge of the touchscreen display, swiping the touchscreen in the first direction comprises swiping the touchscreen from right to left, and swiping the touchscreen in the second direction comprises swiping the touchscreen from left to right.

15. A method as claimed in claim 10, further comprising maintaining the first one of the plurality of menus in a memory operatively connected to the display after the first one of the plurality of menus has been removed from the display.

16. A method as claimed in claim 10, further comprising maintaining the next menu in a memory operatively connected to the display after next menu has been removed from the display.

17. A computer-implemented method for navigating within a first graphical cascade and a second graphical cascade, each graphical cascade comprising a plurality of menus in a stack wherein a first one of the plurality of menus is shown in a foreground and the rest of the plurality of menus are in the background, each graphical cascade being displayed on a touchscreen display, the first graphical cascade being positioned to the left side of the display and second graphical cascade being displayed on the right side of the display, the method comprising the steps of:
(a) swiping the touchscreen from right to left on or near the first cascade to remove the first cascade's first one of the plurality of menus from the display, and cause a next menu in the stack of the first cascade to be displayed in the foreground;
(b) swiping the touchscreen from left to right on or near the second cascade to remove the second cascade's first one of the plurality of menus from the display, and cause a next menu in the stack of the second cascade to be displayed in the foreground.

18. A method as claimed in claim 17, the method comprising the steps of (1) swiping the touchscreen from left to right on or near the first cascade to return the first cascade's first one of the plurality of menus to the display and cause the first cascade's first one of the plurality of menus to be shown in the foreground, and (2) swiping the touchscreen from right to left on or near the second cascade to return the second cascade's first one of the plurality of menus to the display and cause the second cascade's first one of the plurality of menus to be shown in the foreground.

19. A method as claimed in claim 17, further comprising maintaining the first and second cascades' first ones of the plurality of menus in a memory operatively connected to the display after the first and second cascades' first ones of the plurality of menus has been removed from the display.
